(19) United States
(12) Patent Application Publication
(10) Pub. No.: US 2025/0052865 A1
(43) Pub. Date: Feb. 13, 2025

(54) PHOTODETECTION DEVICE AND RANGING DEVICE

(71) Applicant: SONY SEMICONDUCTOR SOLUTIONS CORPORATION, KANAGAWA (JP)

(72) Inventor: SOZO YOKOGAWA, KANAGAWA (JP)

(21) Appl. No.: 18/718,635

(22) PCT Filed: Oct. 27, 2022
(86) PCT No.: PCT/JP2022/040057

§ 371 Date: Jun. 11, 2024

(30) Foreign Application Priority Data
Dec. 21, 2021 (JP) 2021-207156

(51) Int. Cl. G01S 7/481; G01S 7/4863; G01S 7/487; G01S 17/34; G01S 17/58

(52) U.S. Cl. CPC G01S 7/4816; G01S 7/4814; G01S 7/4818; G01S 7/4863; G01S 7/487; G01S 17/34; G01S 17/58; G01S 7/4817

(57) ABSTRACT

A photodetection device of the present disclosure includes: a laser light source that outputs coherent light; two or more photodetectors including respective light-receiving elements, the light-receiving elements being disposed separated from one another, the two or more photodetectors detecting, via the light-receiving elements, reflected light from a subject irradiated with the coherent light; a cross-correlation section that mixes two optical signals detected by any two photodetectors out of the two or more photodetectors; and a heterodyne correlation section that mixes, with heterodyne mixing, the optical signals after mixing by the cross-correlation section or one of the optical signals before mixing by the cross-correlation section and a reference signal obtained by dividing the coherent light from the laser light source.

### TECHNICAL FIELD

The present disclosure relates to a photodetection device and to a ranging device.

### BACKGROUND ART

A technique is known that a subject is dynamically irradiated with coherent light, an optical signal obtained from reflected light from the subject and a reference signal (local signal) obtained by dividing the coherent light are mixed with heterodyne mixing, and based on the resultant, ranging of the subject is performed (for example, see PTLs 1 to 3).

### CITATION LIST

### Patent Literature

PTL 1: US Unexamined Patent Application Publication No. US2020/0018857
PTL 2: Japanese Unexamined Patent Application Publication (Published Japanese Translation of PCT Application) No. JP2020-501130
PTL 3: Japanese Unexamined Patent Application Publication (Published Japanese Translation of PCT Application) No. JP2020-510882

### SUMMARY OF THE INVENTION

Techniques described in PTLs 1 to 3 mentioned above are not sufficient in terms of spatial resolution.

It is desirable to provide a photodetection device and a ranging device that each make it possible to achieve high spatial resolution.

A photodetection device according to one embodiment of the present disclosure includes: a laser light source that outputs coherent light; two or more photodetectors including respective light-receiving elements, the light-receiving elements being disposed separated from one another, the two or more photodetectors detecting, via the light-receiving elements, reflected light from a subject irradiated with the coherent light; a cross-correlation section that mixes two optical signals detected by any two photodetectors out of the two or more photodetectors; and a heterodyne correlation section that mixes, with heterodyne mixing, the optical signals after mixing by the cross-correlation section or one of the optical signals before mixing by the cross-correlation section and a reference signal obtained by dividing the coherent light from the laser light source.

A ranging device according to one embodiment of the present disclosure includes: a laser light source that outputs coherent light; two or more photodetectors including respective light-receiving elements, the light-receiving elements being disposed separated from one another, the two or more photodetectors detecting, via the light-receiving elements, reflected light from a subject irradiated with the coherent light; a cross-correlation section that mixes two optical signals detected by any two photodetectors out of the two or more photodetectors; a heterodyne correlation section that mixes, with heterodyne mixing, the optical signals after mixing by the cross-correlation section or one of the optical signals before mixing by the cross-correlation section and a reference signal obtained by dividing the coherent light from the laser light source; and a signal processor that calculates distance information regarding the subject on a basis of a difference frequency component caused by a cross-correlation signal from the cross-correlation section and the reference signal.

In the photodetection device or the ranging device according to one embodiment of the present disclosure, the two optical signals detected by the any two photodetectors out of the two or more photodetectors are mixed by the cross-correlation section. Further, the optical signals after mixing by the cross-correlation section or one of the optical signals before mixing by the cross-correlation section and the reference signal obtained by dividing the coherent light from the laser light source are mixed, with heterodyne mixing, by the heterodyne correlation section.

### BRIEF DESCRIPTION OF DRAWINGS

FIG. 1 is an explanatory diagram illustrating an overview and resolution of a typical photodetection device.

FIG. 2 is a block diagram illustrating an overall configuration example of a photodetection device and a ranging device according to a comparative example.

FIG. 3 is a block diagram illustrating an overall configuration example of a photodetection device and a ranging device according to a comparative example.

FIG. 4 is a block diagram illustrating one configuration example of a main part of each of the photodetection device and the ranging device according to the comparative example.

FIG. 5 is a block diagram illustrating one configuration example of a main part of each of a photodetection device and a ranging device according to one embodiment of the present disclosure.

FIG. 6 is a block diagram illustrating one configuration example of a main part of each of the photodetection device and the ranging device according to one embodiment.

FIG. 7 is a block diagram illustrating an overall configuration example of the photodetection device and the ranging device according to one embodiment.

FIG. 8 is a block diagram illustrating an overall configuration example of the photodetection device and the ranging device according to one embodiment.

FIG. 9 is a block diagram illustrating an overall configuration example of the photodetection device and the ranging device according to one embodiment.

FIG. 10 is a block diagram illustrating one configuration example of a laser unit in the photodetection device and the ranging device according to one embodiment.

FIG. 11 is a block diagram illustrating one configuration example of an optical splitter in the photodetection device and the ranging device according to one embodiment.

FIG. 12 is a block diagram illustrating one configuration example of an optical mixer in the photodetection device and the ranging device according to one embodiment.

FIG. 13 is a block diagram illustrating one configuration example of a balanced detector in the photodetection device and the ranging device according to one embodiment.

FIG. 14 is an explanatory diagram schematically illustrating a spatial frequency obtained in a case where an antenna interval is short in the photodetection device and the ranging device according to one embodiment.

FIG. 15 is an explanatory diagram schematically illustrating a spatial frequency obtained in a case where an antenna interval is long in the photodetection device and the ranging device according to one embodiment.

FIG. 16 is a block diagram schematically illustrating one example of optical coupling by optical waveguides of three antennas in the photodetection device and the ranging device according to one embodiment.

FIG. 17 is a cross-sectional view schematically illustrating one configuration example of an antenna by silicon photonics technology.

FIG. 18 is a cross-sectional view schematically illustrating one configuration example of an antenna by silicon photonics technology.

FIG. 19 is a cross-sectional view schematically illustrating one configuration example of an antenna by silicon photonics technology.

FIG. 20 is a cross-sectional view schematically illustrating one configuration example of an antenna by silicon photonics technology.

FIG. 21 is a perspective diagram schematically illustrating an arrangement example of light condensing elements with respect to antennas.

FIG. 22 is a planar diagram schematically illustrating an arrangement example of light condensing elements with respect to antennas.

FIG. 23 is a cross-sectional view schematically illustrating one configuration example of a main part of the photodetection device according to one embodiment, by silicon photonics technology.

FIG. 24 is a block diagram schematically illustrating one configuration example of the photodetection device and the ranging device according to one embodiment.

FIG. 25 is a block diagram schematically illustrating one configuration example of the photodetection device and the ranging device according to one embodiment.

FIG. 26 is a cross-sectional view schematically illustrating one configuration example in a case where two optical waveguides are disposed in parallel in a plane by silicon photonics technology.

FIG. 27 is a cross-sectional view schematically illustrating one configuration example in a case where two optical waveguides are disposed in a stacked state by silicon photonics technology.

FIG. 28 is an explanatory diagram schematically illustrating a characteristic example in a case where two optical waveguides are disposed in parallel in a plane by silicon photonics technology.

FIG. 29 is an explanatory diagram schematically illustrating a characteristic example in a case where two optical waveguides are disposed in a stacked state by silicon photonics technology.

FIG. 30 is a planar diagram schematically illustrating one example of optical coupling by an optical waveguide of one antenna.

FIG. 31 is a planar diagram schematically illustrating one example of optical coupling by optical waveguides of an antenna array including a plurality of antennas arranged one-dimensionally.

FIG. 32 is a planar diagram schematically illustrating one example of optical coupling by optical waveguides in an antenna array including a plurality of antennas arranged two-dimensionally.

FIG. 33 is a planar diagram schematically illustrating a configuration example that an optical signal from an antenna array including a plurality of antennas arranged two-dimensionally and a reference signal are optically coupled by optical waveguides arranged in a stacked state.

FIG. 34 is a planar diagram schematically illustrating a configuration example of optical coupling by optical waveguides in a case of taking cross-correlation signals of optical signals from three antennas.

FIG. 35 is an explanatory diagram illustrating one example of a waveform of an optical signal from one antenna.

FIG. 36 is an explanatory diagram illustrating one example of a waveform of a synthesized wave of optical signals from two antennas.

FIG. 37 is an explanatory diagram illustrating one example of an intensity waveform of a synthesized wave of optical signals from two antennas and a reference signal.

FIG. 38 is an explanatory diagram illustrating one example of an intensity waveform of a synthesized wave of optical signals from two antennas and a reference signal.

FIG. 39 is an explanatory diagram illustrating a relationship between imaging information in real space domain and a spatial frequency component in frequency domain.

### MODES FOR CARRYING OUT THE INVENTION

In the following, embodiments of the present disclosure will be described in detail with reference to the drawings. Note that the description will be given in the following order.

### 1. One Embodiment

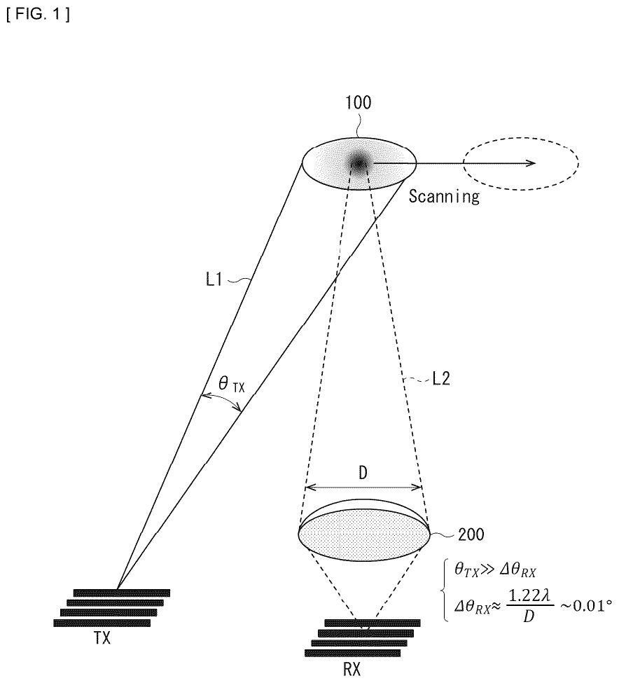

1.1 Overview of Photodetection Device and Ranging Device according to One Embodiment, and Problems (FIGS. 1 to 9)

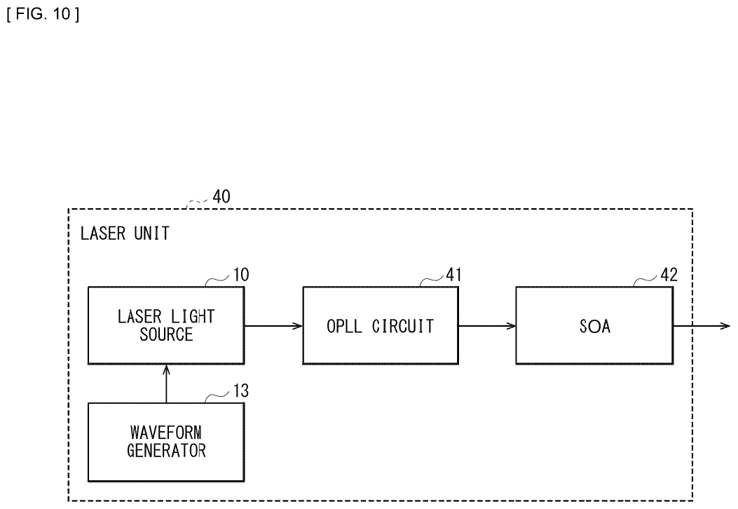

1.2 Specific Configuration Example and Operations (FIGS. 10 to 39)

1.3 Effects

### 2. Other Embodiments

### 1. One Embodiment

### 1.1 Overview of Photodetection Device and Ranging Device According to One Embodiment, and Problems

### (Problems)

A photodetection device causes an optical signal obtained from reflected light from a subject irradiated with coherent light of an SWIR (Short Wavelength Infrared) wavelength region and a reference signal LO (local signal) obtained by dividing the coherent light to be interfered with each other to detect the optical signal. For example, a system is known, as an FMCW (Frequency Modulated Continuous Wave) system, that, with FM (Frequency Modulation) modulation performed on a frequency of coherent light, a frequency difference between a reference signal LO and an optical signal obtained from reflected light L2 is associated with distance information in free space in proportion to light flight time and the distance is estimated. Such an FMCW system is used in a ranging sensor, for example. Here, a silicon optical waveguide is used for an optical circuit in many cases since silicon is transparent in the SWIR wavelength region. As a photodetector that detects light from a subject, an antenna structure referred to as, for example, a grating antenna or grating coupler is used. Light in free space detected by a photodetector is typically taken by an optical waveguide of silicon photonics. Here, the SWIR wavelength is a wavelength of approximately 1.3 μm to 2.0 μm, whereas the photodetector typically has a large size with respect to a desired wavelength, for coupling with light in a periodic structure. In addition, in a case of a plurality of photodetectors included, the photodetectors are typically disposed at a long interval, for example an interval of approximately 50 μm, with respect to a wavelength, for the purpose of reducing optical loss in an optical circuit or the purpose of reducing interference of optical signals between antennas or circuits. Further, typically, in a case of mapping spatial information by a distance sensor of FMCW system, a scan-type ranging sensor of single element is used in many cases. In the scan-type ranging sensor, a laser light source and a photodetector observe the same point of a subject to monitor the whole point irradiated with the laser as one point. Thus, such a ranging sensor of FMCW system performs only spatially sparse sampling and has a disadvantage in that a point rate at a ranging point is low or that imaging in high spatial resolution is difficult.

FIG. 1 illustrates an overview and resolution of a typical photodetection device. A transmitter TX dynamically irradiates a subject 100 with coherent light L1 in a manner of scanning the subject 100. A receiver RX detects reflected light L2 from the subject 100 via an optical system 200 such as a dioptric lens or a reflection mirror. Here, the spatial resolution obtained in the optical system 200 typically has a logical limit. With a wavelength of the reflected light L2 being λ and a diameter of the optical system 200 (diameter of the lens or mirror) being D, a diffraction limit may be expressed as 1.22 λ/D. Here, in a case of the SWIR wavelength region, the wavelength is approximately 1.3 μm to 2 μm, and typically in a case of FMCW Lidar (Light detection and ranging) with basic technologies such as optical communication or silicon photonics, the wavelength is 1.55 μm in many cases. As one example, in a case of the wavelength being 1.55 μm and the diameter of the optical system 200 being 10 mm, the diffraction limit corresponds to an angle Δθ_{Rx} of about 0.01°. Meanwhile, a beam spread angle θ_{Tx} of the coherent light L1 from the transmitter TX is wide as compared with the angle Δθ_{Rx} of the diffraction limit in many cases. In general, the coherent light L1 typically has the beam spread angle θ_{Tx} of approximately 1°, or, even in a case of a collimated beam focused very narrowly, approximately 0.1°. In general, the subject 100 in space is dynamically scanned with the coherent light L1 having the spread angle θ_{Tx} to allow spatial resolution information to be acquired. In other words, the spatial resolution of a known photodetection device such as FMCW Lidar of SWIR wavelength region is determined depending on the beam width or scanning rate of the coherent light L1 from the transmitter TX, having a disadvantage in that spatial resolution information achievable for the receiver RX side is not sufficiently sampled.

Techniques described in PTLs 1 to 3 mentioned above are all a technique related to a system that the optical signal obtained from the reflected light L2 and the reference signal LO are mixed using an optical waveguide to perform heterodyne detection of a difference frequency between the optical signal and the reference signal LO, the system being of directly mixing the reflected light L2 and the reference signal LO. In this case, the reflected light L2 is difficult to have resolution higher than resolution of a reception antenna or spatial resolution corresponding to an irradiation area (spot size) of the laser light source. As described above, the beam spot of the coherent light L1 from the transmitter TX is typically approximately 0.1° to 1°, whereas, in a case where a diameter of a light-receiving camera or a reflection mirror of a ranging sensor of SWIR wavelength band is approximately 10 mm, the angle Δθ_{Rx} of the diffraction limit being a logical resolution limit of the receiver RX side is approximately 0.01°. In other words, known systems disclosed so far have a disadvantage left in that the systems only obtain significantly low spatial resolution information with respect to a logical spatial resolution limit.

### Overview of Photodetection Device and Ranging Device According to One Embodiment

A photodetection device and a ranging device according to one embodiment relate to a technique that enhances spatial resolution of an optical sensor of SWIR wavelength region with an optical circuit being a platform. In particular, the photodetection device and the ranging device relate to Lidar, in which light is dynamically emitted and a distance of a subject 100 and spatial distribution of reflectivity are acquired as two-dimensional image and three-dimensional point cloud information.

First, a description will be given of a configuration of a comparative example for the photodetection device and the ranging device according to one embodiment.

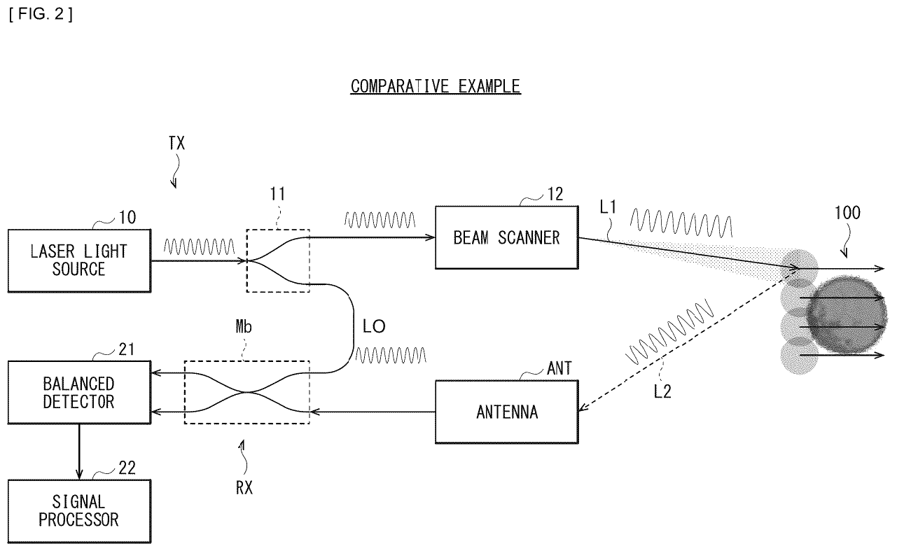

FIG. 2 illustrates an overall configuration example of a photodetection device and a ranging device according to a comparative example.

Each of the photodetection device and the ranging device according to the comparative example includes, as a configuration of a transmitter TX side, a laser light source 10, an optical splitter (Power Divider) 11, and a beam scanner 12.

Further, each of the photodetection device and the ranging device according to the comparative example includes, as a configuration of a receiver RX side, an antenna ANT, an optical mixer Mb, a balanced detector 21, and a signal processor 22.

The laser light source 10 outputs coherent light L1. The laser light source 10 is, for example, a coherent laser light source that emits light in a single mode of SWIR wavelength region of 1.1 μm or more and 2.0 μm or less.

The optical splitter 11 divides the coherent light L1 from the laser light source 10 onto the beam scanner 12 and the optical mixer Mb. The beam scanner 12 dynamically irradiates a subject 100 with the coherent light L1.

The antenna ANT is a light-receiving element including a grating antenna, for example. The antenna ANT receives reflected light L2 from the subject 100 irradiated with the coherent light L1.

The optical mixer Mb is a heterodyne correlation section that mixes, with the heterodyne mixing, an optical signal detected by the antenna ANT and a reference signal LO obtained by dividing the coherent light L1 from the laser light source 10.

The balanced detector 21 converts the optical signal after heterodyne mixing by the optical mixer Mb into an electric signal. The signal processor 22 calculates Doppler velocity of the subject 100 on the basis of the signal obtained by the balanced detector 21. In addition, the signal processor 22 calculates distance information regarding the subject 100 on the basis of the signal obtained by the balanced detector 21.

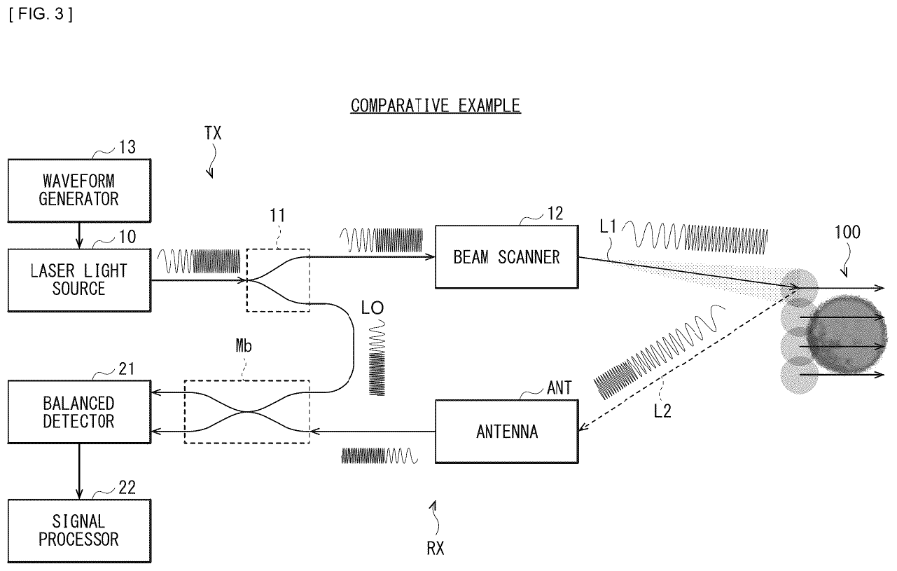

FIG. 3 illustrates an overall configuration example of a photodetection device and a ranging device according to a comparative example.

In FIG. 3, a configuration example of FMCW system is illustrated. In the configuration example illustrated in FIG. 3, a waveform generator 13 is further included. The laser light source 10 and the waveform generator 13 constitute a wavelength swept laser light source configured to continuously change the wavelength of the coherent light L1. In the configuration example illustrated in FIG. 3, the laser light source 10 outputs, as the coherent light L1, laser light with a waveform chirped by wavelength conversion in a time direction.

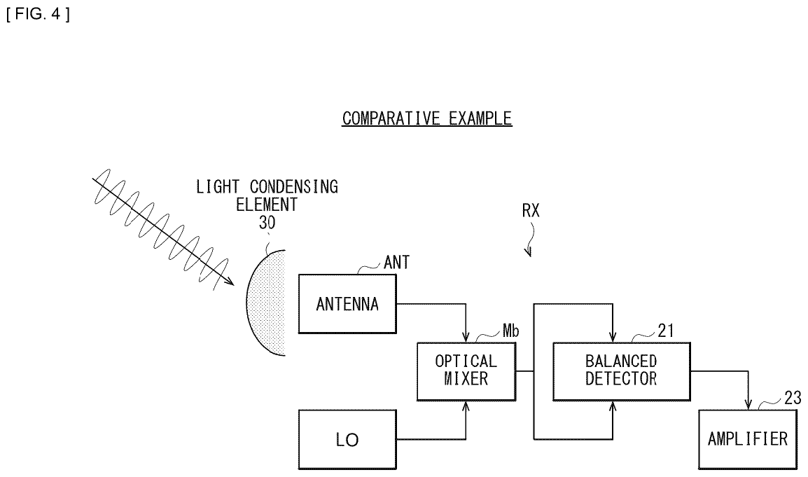

FIG. 4 illustrates one configuration example of a main part of each of the photodetection device and the ranging device according to a comparative example.

In FIG. 4, a configuration of the receiver RX side of each of the photodetection device and the ranging device according to the comparative example is illustrated. For the antenna ANT, a light condensing element 30, such as a condenser lens, that allows a large effective detection area for light may be disposed with respect to a light entering surface. An amplifier 23 may amplify a signal from the balanced detector 21.

Next, a description will be given of a configuration of each of the photodetection device and the ranging device according to one embodiment. Note that, in the following, a part substantially the same as that of the photodetection device and the ranging device according to the above-described comparative example is denoted by the same reference numeral, and that the description is omitted as appropriate.

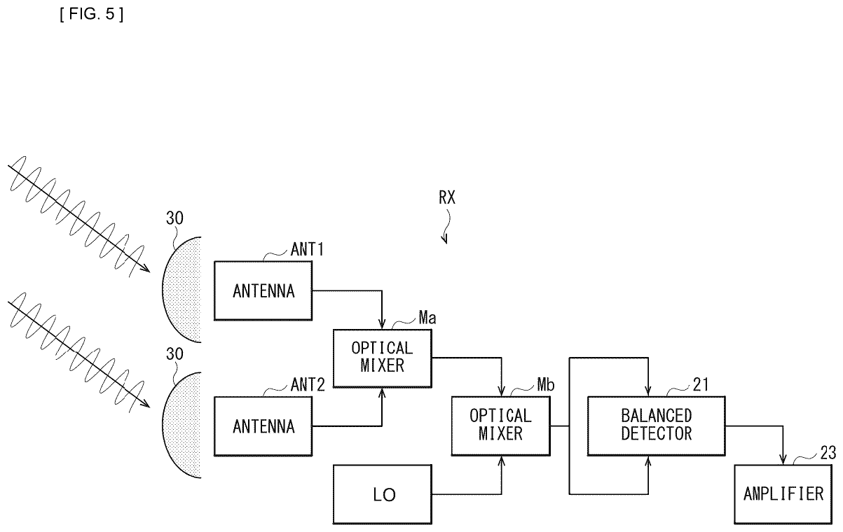

FIG. 5 illustrates one configuration example of a main part of each of the photodetection device and the ranging device according to one embodiment of the present disclosure.

In FIG. 5, a configuration of the receiver RX side of each of the photodetection device and the ranging device according to one embodiment is illustrated. Note that the configuration of the transmitter TX side may be a configuration substantially similar to that of the photodetection device and the ranging device according to the above-described comparative example.

The photodetection device and the ranging device according to one embodiment are each provided with two antennas ANT1 and ANT2, in contrast to that the configuration of the receiver RX side of the above-described comparative example includes only one antenna ANT1. In addition, an optical mixer Ma is further included, as a cross-correlation section that mixes two optical signals detected in the two antennas ANT1 and ANT2.

Each of the antennas ANT1 and ANT2 is a light-receiving element including a grating antenna, for example. The antennas ANT1 and ANT2 are disposed separated from each other, and constitute photodetectors that detect the reflected light L2 from the subject 100 irradiated with the coherent light L1. A light condensing element 30, such as a condenser lens, that allows a large effective detection area for light may be disposed on a light entering surface of each of the antennas ANT1 and ANT2.

The optical mixer Ma mixes two optical signals from the antennas ANT1 and ANT2 to generate a cross-correlation signal.

In the configuration example of FIG. 5, the optical mixer Mb is a heterodyne correlation section that mixes, with heterodyne mixing, the cross-correlation signal generated by the mixing in the optical mixer Ma and the reference signal LO obtained by dividing the coherent light L1 from the laser light source 10. In the configuration example of FIG. 5, a signal after heterodyne mixing by the optical mixer Mb is output to the balanced detector 21.

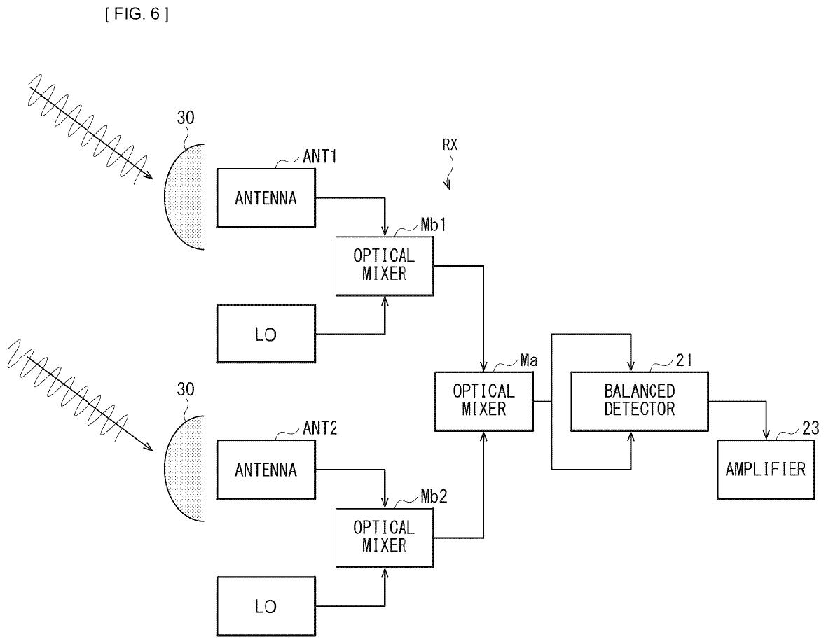

FIG. 6 illustrates one configuration example of a main part of each of the photodetection device and the ranging device according to one embodiment.

In the configuration example of FIG. 6, similarly to the configuration example of FIG. 5, two antennas ANT1 and ANT2 as two photodetectors and an optical mixer Ma as a cross-correlation section are included. Further, in the configuration example of FIG. 6, two optical mixers Mb1 and Mb2 are included as two heterodyne correlation sections.

Each of the two optical mixers Mb1 and Mb2 mixes, with the heterodyne mixing, an optical signal detected in a respective one of the two antennas ANT1 and ANT2 and the reference signal LO to output the resultant to the optical mixer Ma as the cross-correlation section. In the configuration example of FIG. 6, the optical mixer Ma mixes two optical signals after heterodyne mixing by the two optical mixers Mb1 and Mb2 to output the resultant to the balanced detector 21.

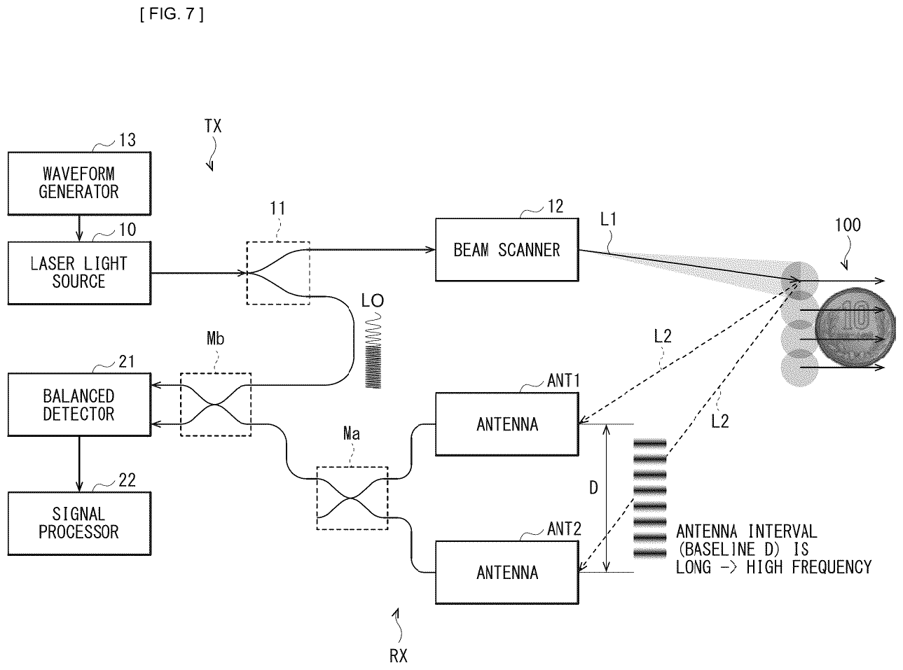

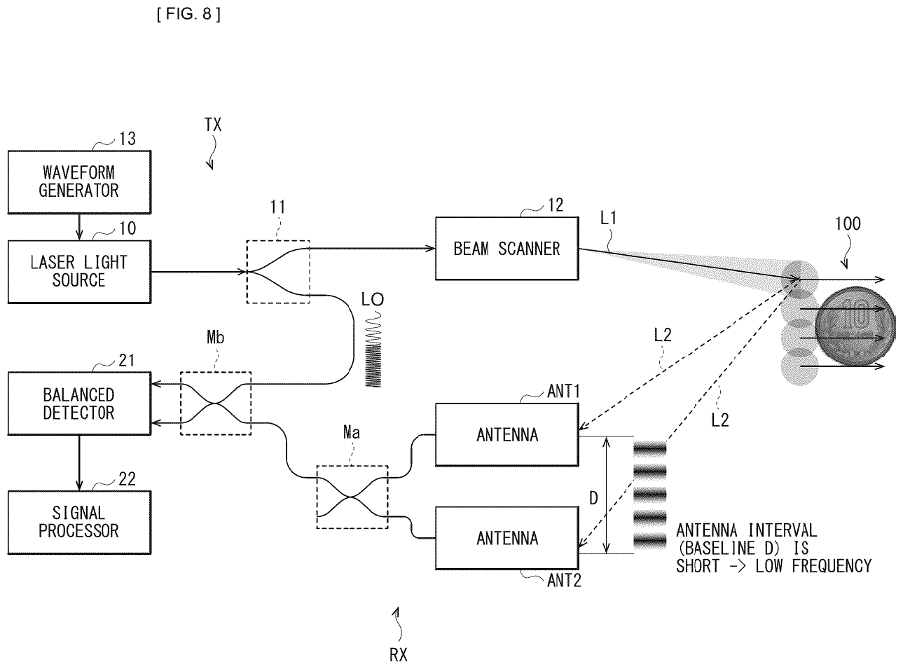

FIGS. 7 and 8 each illustrate an overall configuration example of each of the photodetection device and the ranging device with the receiver RX side having the configuration of FIG. 5. In FIGS. 7 and 8, a configuration example of FMCW system is illustrated.

In the photodetection device and the ranging device according to one embodiment, it is possible for the receiver RX side to obtain optical signals having different spatial frequencies depending on an antenna interval (baseline D) between two antennas ANT1 and ANT2. In a case of a long antenna interval (FIG. 7), it is possible to obtain an optical signal having a high spatial frequency. In a case of a short antenna interval (FIG. 8), in contrast, it is possible to obtain an optical signal having a low spatial frequency.

The reflected light L2 may be different in frequency from the reference signal LO. A frequency difference between the reflected light L2 and the reference signal LO may be 10 GHz or less.

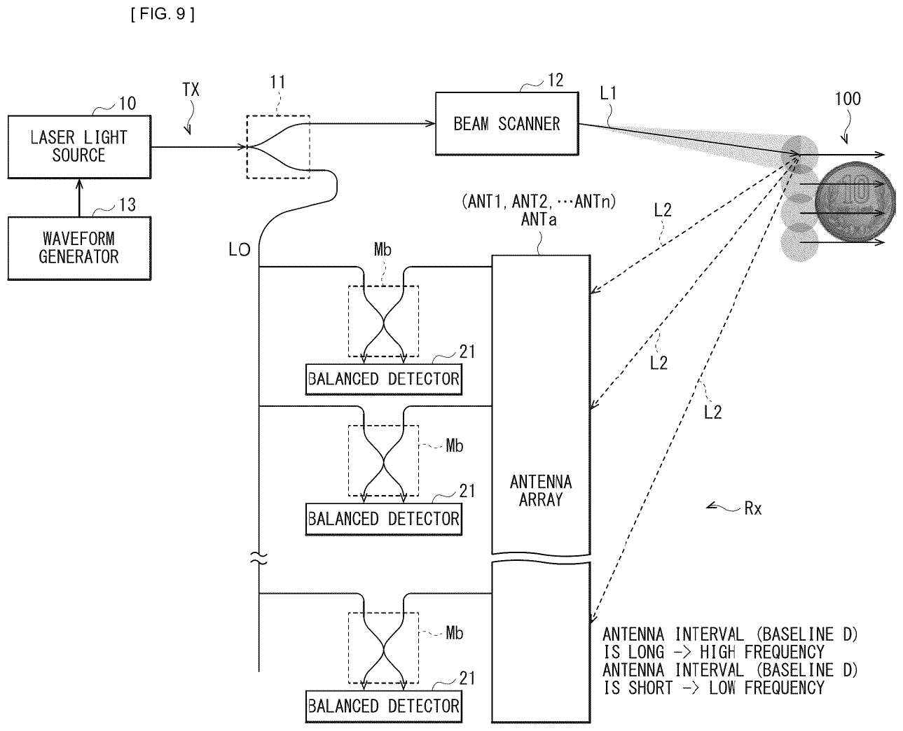

FIG. 9 illustrates an overall configuration example of each of the photodetection device and the ranging device according to one embodiment. In FIG. 9, a configuration example of FMCW system is illustrated.

Although an example including two antennas ANT1 and ANT2 is described above, a configuration may be used that three or more antennas ANT1, ANT2, . . . , ANTn are included as the photodetectors. The three or more antennas ANT1, ANT2, . . . , ANTn may be included as an antenna array ANTa.

In the following, one antenna in a person position out of the plurality of antennas ANT1, ANT2, . . . , ANTn is referred to as an antenna ANTn.

As described above, the photodetection device and the ranging device according to one embodiment each include two or more photodetectors. The two or more photodetectors include respective light-receiving elements (antennas ANTn). The respective light-receiving elements (antennas ANTn) are disposed separated from one another. The two or more photodetectors detect, via the light-receiving elements (antennas ANTn), the reflected light L2 from the subject 100 irradiated with the coherent light L1. Further, the cross-correlation section (optical mixer Ma) is included that mixes two optical signals detected in any two photodetectors out of the two or more photodetectors. Further, the heterodyne correlation section (optical mixer Mb) is included that mixes, with heterodyne mixing, the optical signals after mixing by the cross-correlation section (optical mixer Ma) and the reference signal LO obtained by dividing the coherent light L1 from the laser light source 10 (for example, FIG. 5). Alternatively, the heterodyne correlation sections (optical mixers Mb1 and Mb2) are included that each mix, with heterodyne mixing, one of the optical signals before mixing by the cross-correlation section (optical mixer Ma) and the reference signal LO obtained by dividing the coherent light L1 from the laser light source 10 (for example, FIG. 6).

In the photodetection device and the ranging device according to one embodiment, as described below, each of the two or more photodetectors may be provided on a silicon substrate and include a grating antenna in which the reflected light L2 from free space enters. The grating antenna and the balanced detector 21 may be coupled with each other via an optical waveguide.

Further, each of the photodetection device and the ranging device according to one embodiment may include one or a plurality of functional blocks each including the any two photodetectors, the cross-correlation section (optical mixer Ma), and the heterodyne correlation section(s) (optical mixer Mb or optical mixers Mb1 and Mb2). Each of the functional blocks may include a function of sampling a spatial frequency component determined depending on a relative positional relationship between respective photodetection elements of the any two photodetectors.

Further, in the photodetection device and the ranging device according to one embodiment, each of the two or more photodetectors may include an optical lens function that allows a large effective detection area. Further, each of the two or more photodetectors may include an optical condensing mirror function that allows a large effective detection area.

Further, in the photodetection device and the ranging device according to one embodiment, the balanced detector 21 may perform current detection on a difference frequency component caused by the cross-correlation signal and the reference signal LO, the cross-correlation signal being generated by mixing in the cross-correlation section (optical mixer Ma).

Further, in the photodetection device and the ranging device according to one embodiment, the signal processor 22 may perform aperture synthesis processing, the aperture synthesis processing including sampling, on the basis of the difference frequency component, a spatial frequency component corresponding to a relative positional relationship between the light-receiving elements (antennas ANTn) in the any two photodetectors and converting the spatial frequency component into intensity distribution in real space by signal processing.

Further, in the photodetection device and the ranging device according to one embodiment, each of the two or more photodetectors may be provided on a silicon substrate, and on the silicon substrate, a first optical waveguide that guides the reflected light L2 and a second optical waveguide that guides the reference signal LO may be stacked at positions different from each other in a stacking direction.

Further, in the photodetection device and the ranging device according to one embodiment, each of the first optical waveguide and the second optical waveguide may mainly include single crystal silicon or silicon nitride, and a flattening layer may be provided between the first optical waveguide and the second optical waveguide on the silicon substrate, the flattening layer mainly including a silicone oxide film having a thickness of 100 nm or more and 1000 nm or less.

Further, in the photodetection device and the ranging device according to one embodiment, the signal processor 22 may calculate Doppler velocity of the subject 100 in a sight direction of the two or more photodetectors on the basis of wavelength shift information regarding the coherent light L1 calculated on the basis of the difference frequency component caused by the cross-correlation signal from the cross-correlation section (optical mixer Ma) and the reference signal LO.

Further, in the photodetection device and the ranging device according to one embodiment, the signal processor 22 may calculate distance information regarding the subject 100 on the basis of the difference frequency component caused by the cross-correlation signal from the cross-correlation section (optical mixer Ma) and the reference signal LO.

In the comparative examples in FIGS. 2 to 4, the coherent light L1 is dynamically applied, and two systems of light, namely the reflected light L2 and the reference signal LO are mixed, for heterodyne detection. In contrast, in the photodetection device and the ranging device according to one embodiment, the minimum components include receiving two systems of reflected light L2, and mixing the reflected light L2 and the reference signal LO, in other words three systems of light.

In the configuration of the comparative examples, mapping is possible only in spatial resolution corresponding to a spread of irradiation spot of the light source, whereas in the photodetection device and the ranging device according to one embodiment, sampling of a spatial frequency component is possible in angular resolution (1.22 λ/D) corresponding to a physical interval (baseline D) between the two photodetectors. Such a plurality of photodetectors allows sampling of spatial frequency components corresponding to respective pairings of the photodetectors. With a pair of two detectors having a long interval, it is possible to acquire a high spatial frequency component. With a pair of two detectors having a short interval, it is possible to acquire a low spatial frequency component. Reconstructing these components in later signal processing allows imaging in high spatial resolution, so called aperture synthesis.

Further, each of the photodetection device and the ranging device according to one embodiment is assumed to include two or more photodetectors (antennas ANTn), and causes reflection components of optical signals to be mixed with homodyne mixing and causes the reference signal LO to be mixed with heterodyne mixing. In a case of causing the signals to be multiplexed by using, for example, a plurality of silicon optical waveguides, the plurality of silicon optical waveguides is to be adjacent to each other. Since the optical signals propagate in the optical waveguides in a state of light, the optical waveguides are to be routed on a chip, for example. In this case, as the number N of light-receiving elements (antennas ANTn) increases, the number of pairings between the light-receiving elements increases to N*(N−1)/2 pairings. Thus, as described below, an optical waveguide propagating the reflected light L2 and an optical waveguide propagating the reference signal LO may be stacked in different layers. This allows degree of freedom of routing the optical waveguides to be enhanced.

### 1.2 Specific Configuration Example and Operations

### (Configuration Example of Components)

FIG. 10 illustrates one configuration example of a laser unit 40 in the photodetection device and the ranging device according to one embodiment.

In the photodetection device and the ranging device according to one embodiment, the laser light source 10 may be included in the laser unit 40 as illustrated in FIG. 10. The laser unit 40 may include the laser light source 10, the waveform generator 13, an OPLL (Optical Phase Locked Loop) circuit 41, and an SOA (Semiconductor Optical Amplifier) 42.

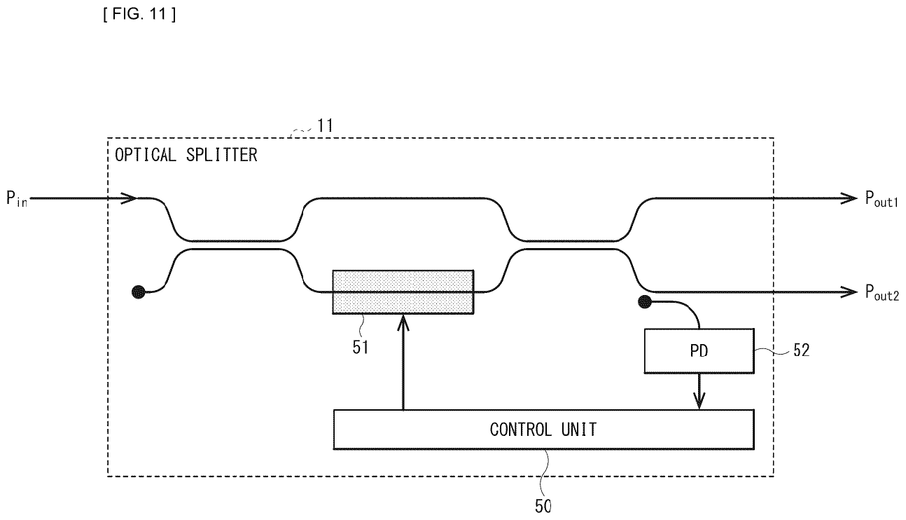

FIG. 11 illustrates one configuration example of the optical splitter 11 in the photodetection device and the ranging device according to one embodiment.

The optical splitter 11 may include a control unit 50, a phase adjuster 51, and a PD (photo diode) 52.

An input signal Pin to the optical splitter 11 may be input into the phase adjuster 51. The optical splitter 11 may output output signals Pout1 and Pout2.

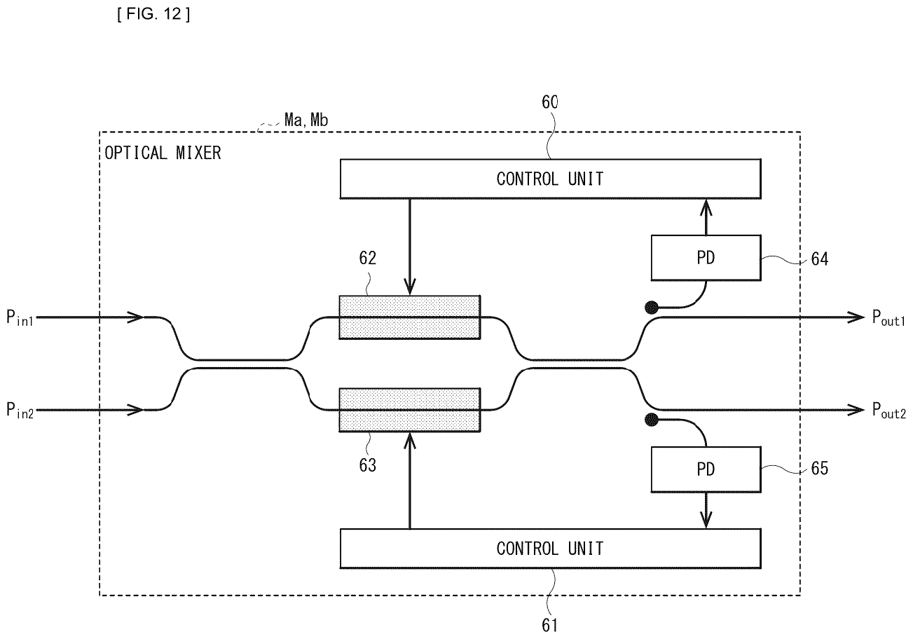

FIG. 12 illustrates one configuration example of the optical mixers Ma and Mb in the photodetection device and the ranging device according to one embodiment.

The optical mixers Ma and Mb may each include a control unit 60, a control unit 61, a phase adjuster 62, a phase adjuster 63, a PD (photo diode) 64, and a PD (photo diode) 65.

Each of the phase adjuster 62 and the phase adjuster 63 is an optical path length adjustment function section that adjusts a phase difference of an optical signal or the reference signal LO.

Each of the optical mixers Ma and Mb may receive input signals Pin1 and Pin2. Each of the optical mixers Ma and Mb may output output signals Pout1 and Pout2.

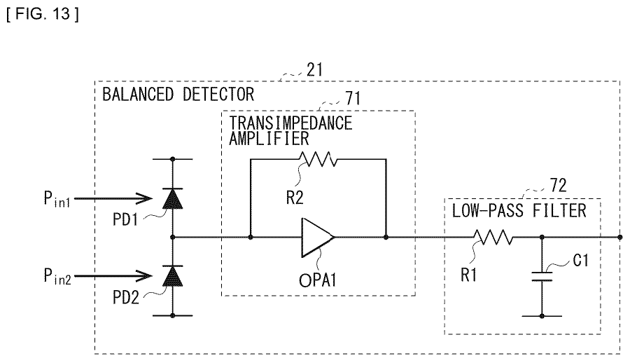

FIG. 13 illustrates one configuration example of the balanced detector 21 in the photodetection device and the ranging device according to one embodiment.

The balanced detector 21 may receive input signals Pin1 and Pin2. The balanced detector 21 may include photo diodes PD1 and PD2, a transimpedance amplifier 71, and a low-pass filter 72.

The transimpedance amplifier 71 includes an operational amplifier OPA1 and a resistance element R1. The low-pass filter 72 may include a resistance element R1 and a capacitance element C1.

(Difference from Typical FMCW Lidar)

A response of an electromagnetic wave in a case of heterodyne mixing with a typical FMCW system is shown below. A reflected signal obtained from the reflected light L2 is expressed as V_{Rx}, and the reference signal LO is expressed as V_{LO}. Here, two-wave synthesis of mixing two types of light, namely V_{Rx} and V_{LO}, is shown.

V_{Rx}=V₁ sin A

V_{LO}=V_{L} sin B

Here, any phases A and B may each be expressed as below. ω refers to an oscillation frequency of a reflected wave, ω_{L} refers to an oscillation frequency of the reference signal LO (local signal), t refers to a time, and θ refers to a phase delay amount of a signal.

$$A = ω t + θ , B = {ω}_{L} t$$

Further, mixed output electric power Pₘᵢₓ of V_{Rx} and V_{LO} may be expressed as below.

$${P}_{mix} = {( {V}_{1} sin A + {V}_{LO} sin B )}^{2}$$

With the above expression deformed, the expression (1) is obtained as below.

$$\begin{matrix}[ Math . 1 ] & \\ {P}_{mix} = \frac{{V}_{1}^{2} + {V}_{L}^{2}}{2} - \frac{{V}_{1}^{2}}{2} cos 2 ( ω t + θ ) - \frac{{V}_{L}^{2}}{2} cos ( 2 {ω}_{L} t ) - {V}_{1} {V}_{L} cos ( ( ω + {ω}_{L} ) t + θ ) + {V}_{1} {V}_{L} cos ( ( ω - {ω}_{L} ) t + θ ) & ( 1 )\end{matrix}$$

Here, it is understood that the first term is a term of a DC component, and each of the second, third, and fourth terms is a term that oscillates in a frequency obtained by multiplying that of the reflected light L2 or reference signal LO by two. It is understood that the fifth term at last is a term of a difference frequency component (beat component) of (ω−ω_{L}). Each of the second, third, and fourth terms is a term of high frequency oscillation with a light source wavelength, and thus is possible to be filtered by the low-pass filter. In other words, mixing the reflected light L2 and the reference signal LO and filtering the high frequency component allow the difference frequency component between the reflected light L2 and the reference signal LO to be selectively extracted from a two-wave synthesized signal for detection. The above are the principles of heterodyne detection used in typical FMCW Lidar.

Next, three-wave synthesis performed with a technique according to one embodiment will be described. Similarly to the case of two-wave synthesis, the reflected signals are expressed as V_{Rx1} and V_{Rx2}, and the reference signal LO is expressed as V_{LO}.

V_{Rx1}=V₁ sin A

V_{Rx2}=V₂ sin B

V_{LO}=V_{L} sin C

Here, phases A, B, and C may each be expressed as below. ω refers to an oscillation frequency of a reflected wave, ω_{L} refers to an oscillation frequency of the reference signal LO, t refers to a time, and θ₁ and θ₂ each refer to a phase delay amount of a signal.

$$A = ω t + {θ}_{1} , B = ω t + {θ}_{2} , C = {ω}_{L} t$$

Similarly to the case of two-wave synthesis, the output electric power Pₘᵢₓ of three-wave synthesis of V_{Rx1}, V_{Rx2}, and V_{LO} may be expressed as the following expression.

$${P}_{mix} = {( {V}_{1} sin A + {V}_{2} sin B + {V}_{LO} sin C )}^{2}$$

With the above expression deformed, the expression (2) is obtained as below.

$$\begin{matrix}[ Math . 2 ] & \\ {P}_{mix} = \frac{{V}_{1}^{2} + {V}_{2}^{2} + {V}_{L}^{2}}{2} - \frac{3}{2} ( {V}_{1}^{2} cos 2 ( ω t + {θ}_{1} ) + {V}_{2}^{2} cos 2 ( ω t + {θ}_{2} ) + {V}_{L}^{2} cos 2 ( {ω}_{L} t ) ) - {V}_{1} {V}_{2} cos ( 2 ω t + {θ}_{1} + {θ}_{2} ) - {V}_{2} {V}_{L} cos ( ( ω + {ω}_{L} ) t + {θ}_{2} ) - {V}_{L} {V}_{1} cos ( ( ω + {ω}_{L} ) t + {θ}_{1} ) + {V}_{1} {V}_{2} cos ( {θ}_{1} - {θ}_{2} ) + {V}_{2} {V}_{L} cos ( ( ω - {ω}_{L} ) t + {θ}_{2} ) + {V}_{L} {V}_{1} cos ( ( ω - {ω}_{L} ) t + {θ}_{1} ) & ( 2 )\end{matrix}$$

Similarly to the case of two-wave synthesis, the terms are of a DC component, an oscillation term of two-multiplication of the reflected light L2 or reference signal LO, and a difference frequency component. The oscillation component of two-multiplication is possible to be filtered by the low-pass filter. The difference frequency component between the reflected light L2 and the reference signal LO is a beat signal of a low frequency in GHz band, and thus the component is possible to be detected by the balanced detector 21. Note that two terms of difference frequency components may be put together into one term, as in the following expression (3). Here, phase differences of θ₁ and θ₂ are included in the term of cos(θ₁−θ₂), and thus it is understood that an amplitude oscillates depending on a phase difference between antennas receiving two systems of the reflected signals V_{Rx1} and V_{Rx2}.

$$\begin{matrix}[ Math . 3 ] & \\ {V}_{L} {V}_{2} cos ( ( ω - {ω}_{L} ) t + {θ}_{2} ) + {V}_{L} {V}_{1} cos ( ( ω - {ω}_{L} ) t + {θ}_{1} ) = \sqrt{{V}_{L}^{2} {V}_{L}^{2} + {V}_{1} {V}_{1}^{2} {V}_{L}^{2} + 2 {V}_{1} {V}_{2} {V}_{L}^{2} cos ( {θ}_{1} - {θ}_{2} )} cos ( ( ω - {ω}_{L} ) t + {θ}_{2} + β ) β = {tan}^{- 1} ( \frac{Y sin Δ}{X + Y cos Δ} ) + \{ \begin{matrix}0 \\ π\end{matrix} & ( 3 )\end{matrix}$$

In other words, the photodetection device and the ranging device according to one embodiment each make it possible to acquire, as interference fringe of the amplitude information regarding the difference frequency component from the reference signal LO, phase difference information regarding a distance from the subject 100 to the antennas ANT1 and ANT2, the phase difference information caused corresponding to a physical interval between the two photodetectors (antennas ANT1 and ANT2). In a case of two photodetectors, the acquiring is possible for one antenna pair. In a case of three detectors (A, B, and C), the acquiring is possible for three pairs, namely AB pair, BC pair, and CA pair, are acquired. In such a manner, spatial frequency components are possible to be acquired for six pairs in a case of four antennas, or for N*(N−1)/2 pairs in a case of N antennas.

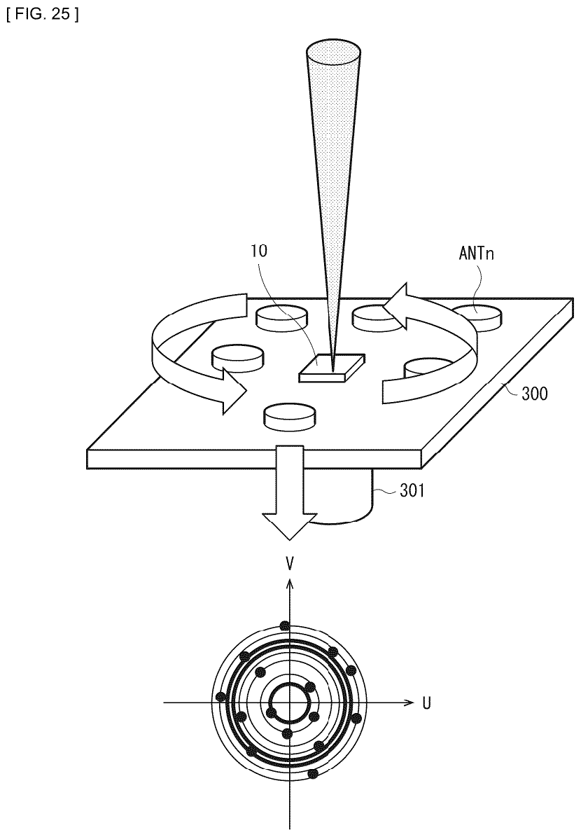

Next, a case where positions of the subject 100 and the laser light source 10 are fixed is considered. In a case where the subject 100 is assumed not to move in a significantly long time scale for a time interval to sample reflection information, a detector in a position changeable with the positional relationship between the laser light source 10 and the subject 100 fixed allows spatial phase information different from that of an initial position to be acquired. Specifically, a photodetector is disposed on a rotary stage or an XY stage and caused to be slightly changed in position of the photodetector, and thus it is possible to obtain different spatial frequency components depending on time (see FIG. 25 described below). It is known that imaging information in real space domain and a spatial frequency component in frequency domain have a relationship of Fourier transform and inverse Fourier transform. Thus, acquiring many types of spatial frequency components is equivalent to acquiring many types of Fourier components, allowing imaging information of higher quality to be structured

Here, the number of photodetectors increased to multiple numbers leads a concern of routing of a silicon optical waveguide that guides light. The silicon optical waveguide causes light to be guided, with silicon and/or silicon nitride having a high refractive index as a core. Further, for detection of interference fringe in SWIR wavelength band by mixing with the reference signal LO, unevenness in optical path length of the optical waveguide is to be managed to be small enough for the wavelength, specifically, in a case of SWIR wavelength of 1.55 μm, approximately 1/10 of 1.55 μm, or less. Thus, there are a variety of technical issues in a phase adjuster that makes fine adjustments thermally or electrically on the optical path length in the optical waveguide and in contrivance that minimizes a propagation loss in the optical waveguide. Optical elements, such as grating couplers being photodetectors or 3 dB couplers for optical mixing with a local frequency of the reference signal LO are required to be densely provided on a PIC (Photonic IC).

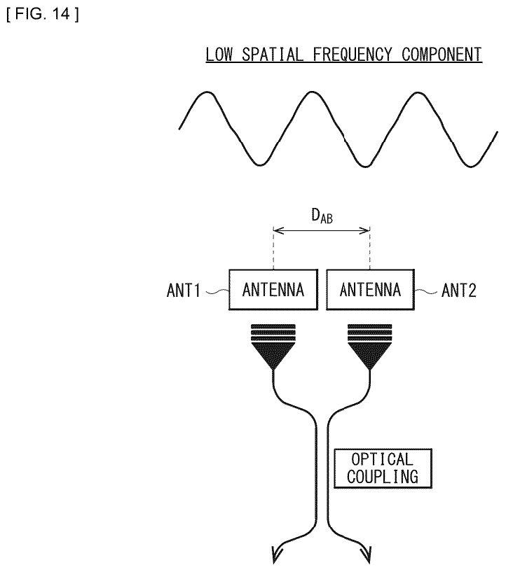

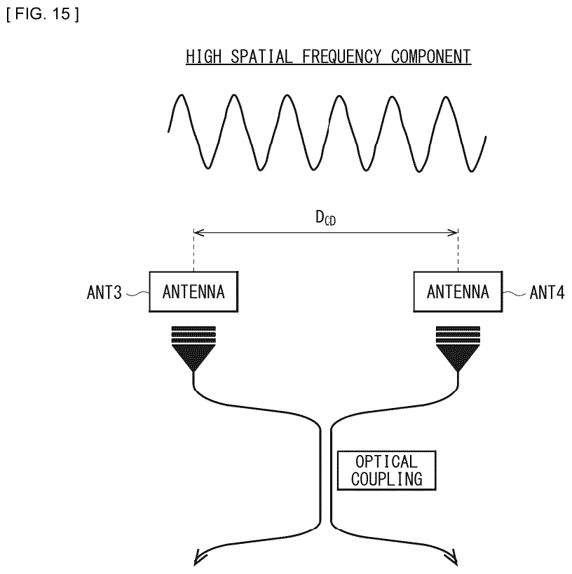

FIG. 14 schematically illustrates a spatial frequency obtained in a case where an antenna interval is short in the photodetection device and the ranging device according to one embodiment. FIG. 15 schematically illustrates a spatial frequency obtained in a case where an antenna interval is long in the photodetection device and the ranging device according to one embodiment.

In FIG. 14, the interval (baseline) between two antennas ANT1 and ANT2 is D_{AB}. In FIG. 15, the interval (baseline) between two antennas ANT3 and ANT4 is D_{CD}. D_{AB}<D_{CD}, thus in the configuration of FIG. 15, a high spatial frequency component is obtained as compared with the configuration of FIG. 14.

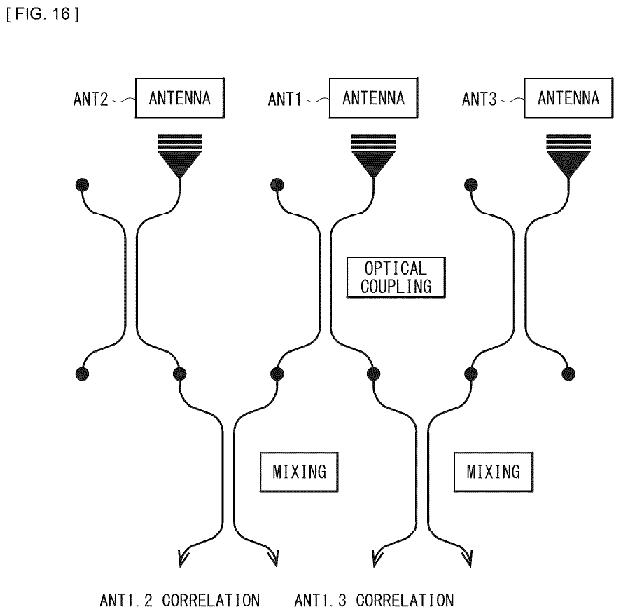

FIG. 16 schematically illustrates one example of optical coupling by optical waveguides of three antennas ANT1, ANT2, and ANT3 in the photodetection device and the ranging device according to one embodiment.

In the configuration example of FIG. 16, among three antennas ANT1, ANT2, and ANT3, a cross-correlation signal of the antenna ANT1 and antenna ANT2 and a cross-correlation signal of the antenna ANT1 and antenna ANT3 are obtained.

### Configuration Example by Silicon Photonics Technology

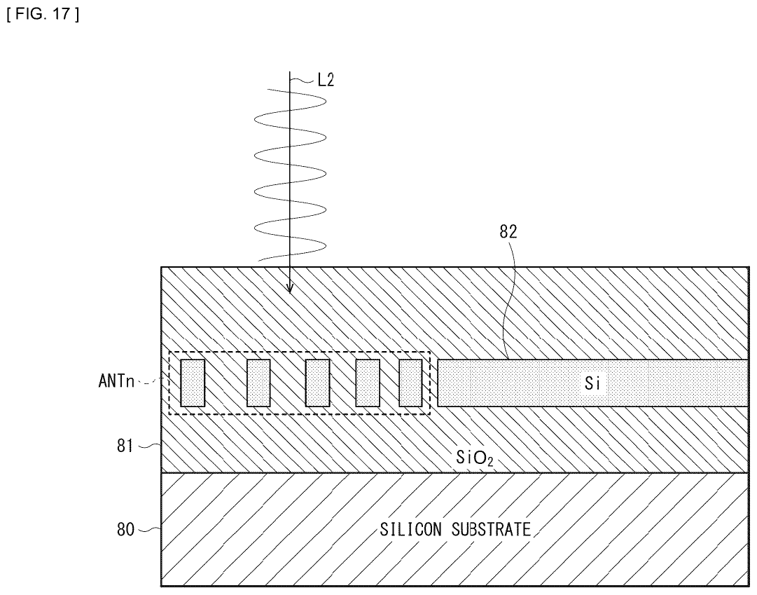

FIG. 17 schematically illustrates a cross-sectional configuration example of antennas ANTn by silicon photonics technology.

In the configuration example of FIG. 17, an SiO₂ film 81 is stacked on a silicon substrate 80. Grating antennas as the antennas ANTn and an Si waveguide 82 are formed in the SiO₂ film 81.

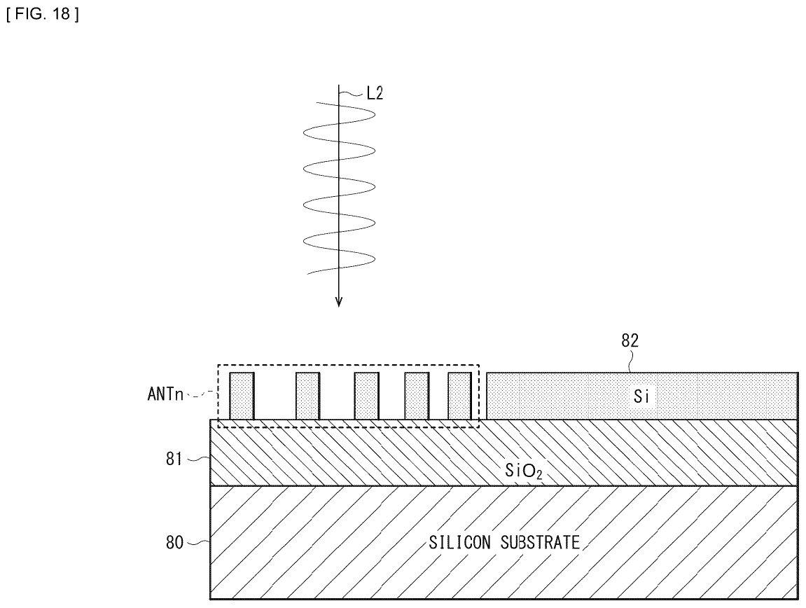

FIG. 18 schematically illustrates a cross-sectional configuration example of antennas ANTn by silicon photonics technology.

In the configuration example of FIG. 18, an SiO₂ film 81 is stacked on a silicon substrate 80. Further, grating antennas as the antennas ANTn and an Si waveguide 82 are stacked on the SiO₂ film 81. There is air between the grating antennas as the antennas ANTn and the Si waveguide 82.

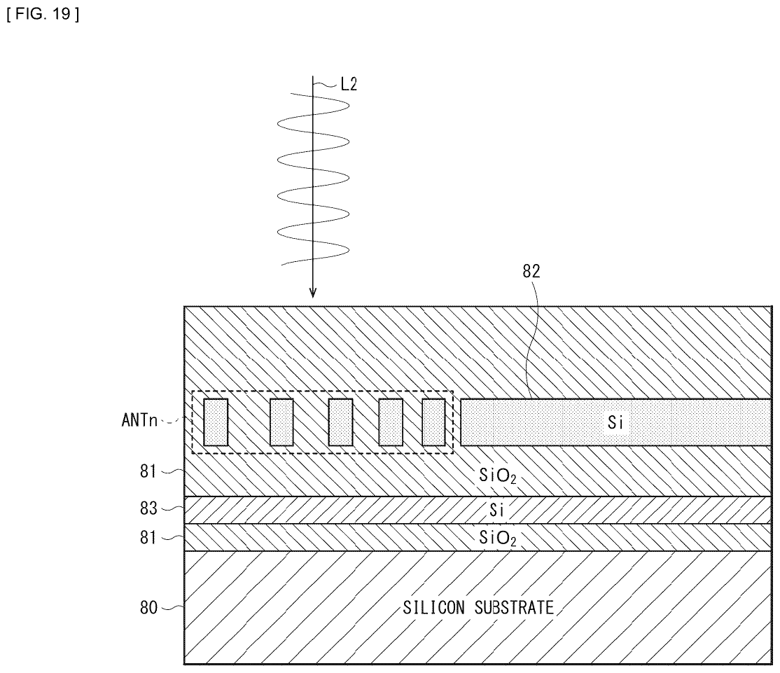

FIG. 19 schematically illustrates a cross-sectional configuration example of antennas ANTn by silicon photonics technology.

In the configuration example of FIG. 19, an Si mirror layer 83 is formed as a layer lower than grating antennas as the antennas ANTn and an Si waveguide 82 in an SiO₂ film 81, with respect to the configuration example of FIG. 17. The Si mirror layer 83 includes an optical condensing mirror function that allows a large effective detection area for the antennas ANTn.

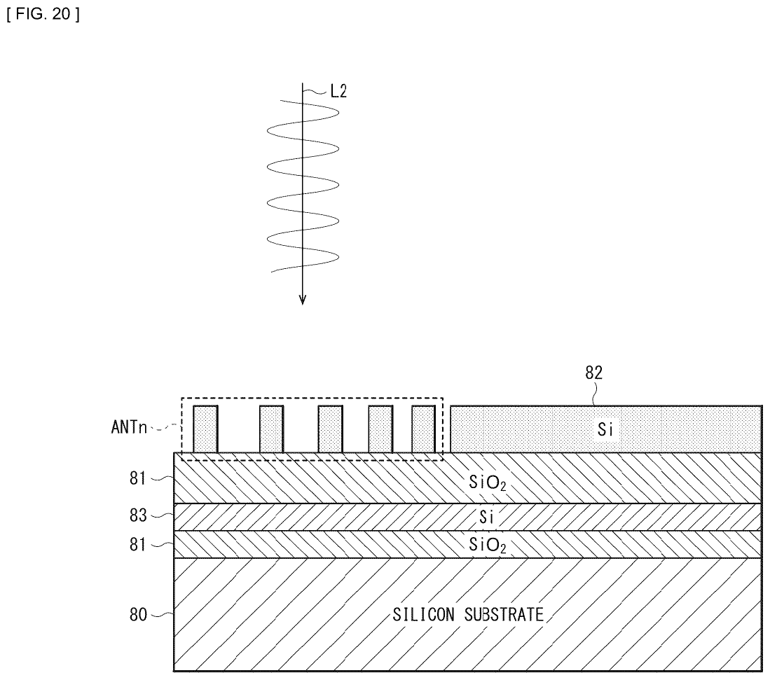

FIG. 20 schematically illustrates a cross-sectional configuration example of antennas ANTn by silicon photonics technology.

In the configuration example of FIG. 20, an Si mirror layer 83 is formed in an SiO₂ film 81, with respect to the configuration example of FIG. 18. The Si mirror layer 83 includes an optical condensing mirror function that allows a large effective detection area for the antennas ANTn.

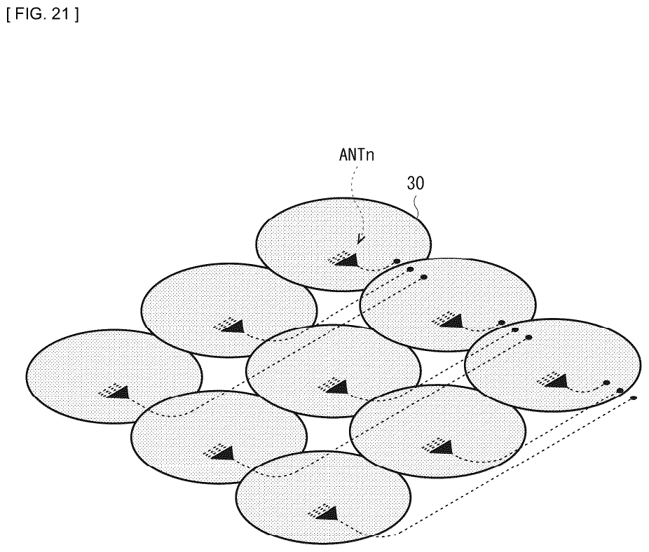

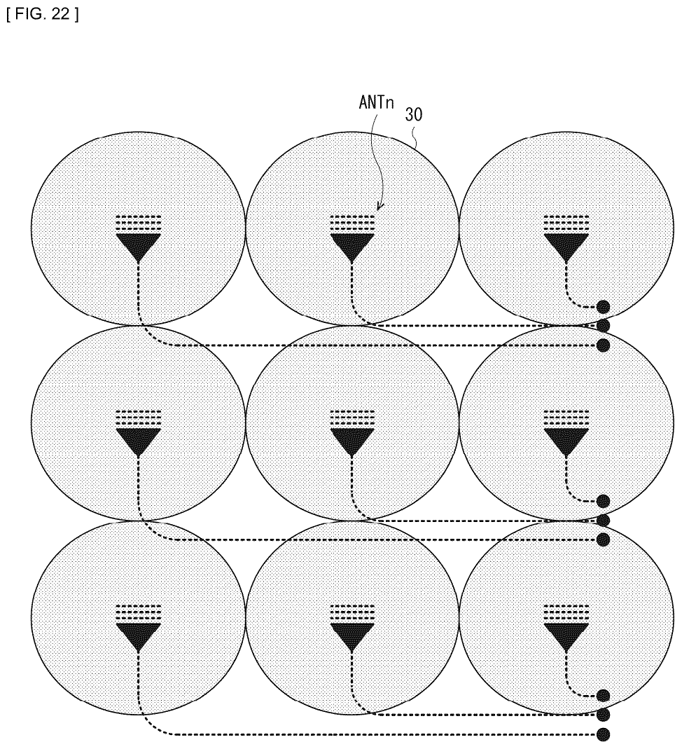

FIG. 21 is a perspective diagram schematically illustrating an arrangement example of light condensing elements 30 with respect to antennas ANTn. FIG. 22 is a planar diagram schematically illustrating an arrangement example of the light condensing elements 30 with respect to the antennas ANTn.

A light condensing element 30 may be disposed with respect to a light entering surface of each of the plurality to antennas ANT1, ANT2, . . . , ANTn. In each of FIGS. 21 and 22, an example is illustrated that condenser lenses each having a circular planar shape are arranged as the light condensing elements 30. The light condensing elements 30 each include an optical lens function that allows a large effective detection area for each of the plurality of antennas ANT1, ANT2, . . . , ANTn.

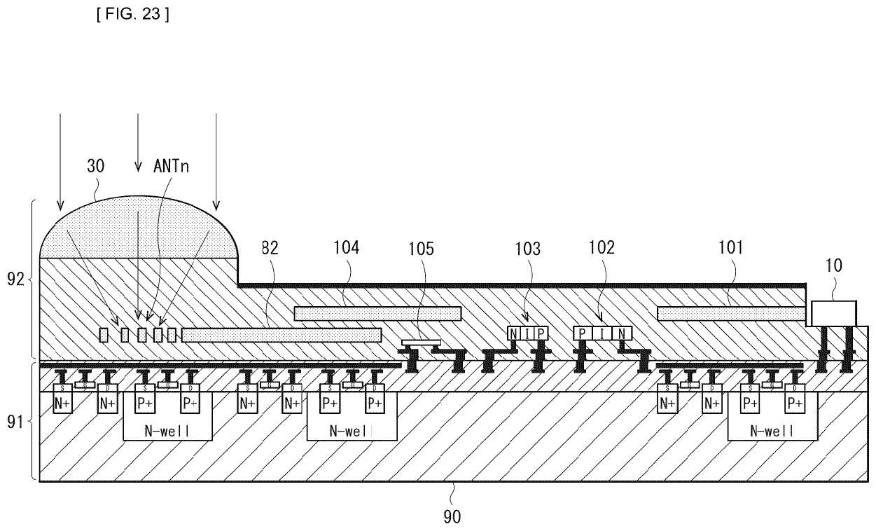

FIG. 23 schematically illustrates a cross-sectional configuration example of a main part of the photodetection device according to one embodiment by silicon photonics technology.

The main part of the photodetection device according to one embodiment may be formed on a CMOS (Complementary Metal Oxide Semiconductor) wafer 90, for example. The CMOS wafer 90 includes an electrical layer 91 and a photonic layer 92, the electrical layer including a CMOS circuit formed.

The electrical layer 91 includes the CMOS circuit formed. The photonic layer 92 includes, for example in an SiO₂ layer, grating antennas as the antennas ANTn, the Si waveguide 82, a waveguide 101 for LO, a phase adjuster 102, a photodetector 103, a waveguide 104 for LO, and a heater 105. A light condensing element 30 is disposed in a stacked state at a position corresponding to a light entering surface of the antennas ANTn.

The Si waveguide 82 is the first optical waveguide that guides the reflected light L2 from the antennas ANTn. Each of the waveguide 101 for LO and the waveguide 104 for LO is the second optical waveguide that guides the reference signal LO. The first optical waveguide and the second optical waveguide are stacked at positions different from each other in the stacking direction.

### Configuration Example with Rotation Mechanism

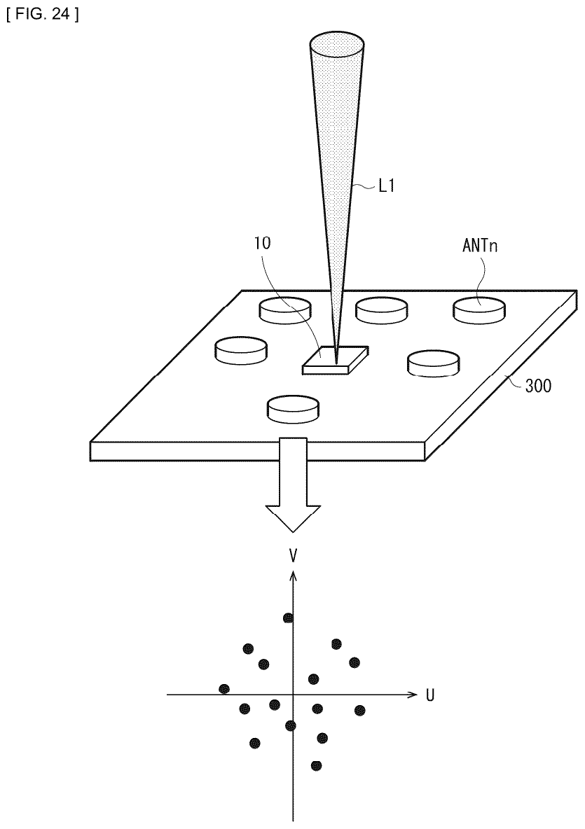

FIG. 24 schematically illustrates one configuration example of each of the photodetection device and the ranging device according to one embodiment.

Each of the photodetection device and the ranging device according to one embodiment may have a configuration where the laser light source 10 that outputs the coherent light L1 and the plurality of antennas ANTn are disposed on a photonic IC (Integrated Circuit) chip 300.

FIG. 25 schematically illustrates one configuration example of each of the photodetection device and the ranging device according to one embodiment.

For example, as illustrated in FIG. 25, a rotation mechanism 301 may be provided on the bottom surface side of the photonic IC chip 300, with respect to the configuration of FIG. 24. With this, even if the position between the subject 100 and the laser light source 10 are fixed, for example, rotating the photonic IC chip 300 makes a change in position between each of the antennas ANTn and the subject 100. Thus, it is possible to obtain different spatial frequency components depending on time. It is known that imaging information in real space domain and a spatial frequency component in frequency domain have a relationship of Fourier transform and inverse Fourier transform. Thus, acquiring many types of spatial frequency components is equivalent to acquiring many types of Fourier components, allowing imaging information of higher quality to be structured.

### (Arrangement Example of Optical Waveguides)

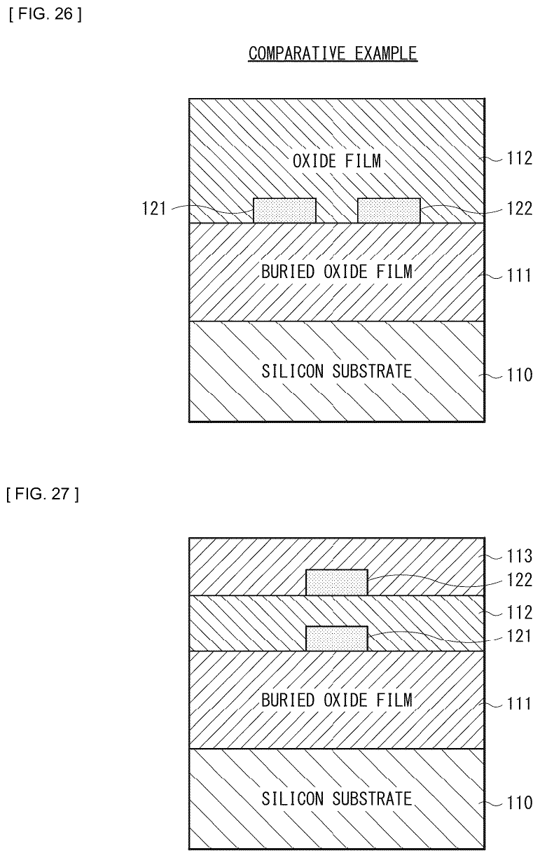

FIG. 26 schematically illustrates a cross-sectional configuration example in a case where two optical waveguides 121 and 122 are disposed in parallel in a plane by silicon photonics technology.

In the configuration example of FIG. 26, a buried oxide film 111 and an oxide film 112 are stacked on a silicon substrate 110, and the two optical waveguides 121 and 122 are disposed in parallel in the oxide film 112.

FIG. 27 schematically illustrates a cross-sectional configuration example in a case where two optical waveguides 121 and 122 are disposed in a stacked state by silicon photonics technology.

In the configuration example of FIG. 27, a buried oxide film 111 and oxide films 112 and 113 are stacked on a silicon substrate 110, and the two optical waveguides 121 and 122 are respectively disposed in a stacked state in the oxide films 112 and 113. The optical waveguide 121 may be the first optical waveguide that guides the reflected light L2, for example. The optical waveguide 121 may be the second optical waveguide that guides the reference signal LO, for example. Thus, the first optical waveguide and the second optical waveguide may be stacked at positions different from each other in the stacking direction. Each of the first optical waveguide and the second optical waveguide may mainly include single crystal silicon or silicon nitride. A flattening layer mainly includes a silicone oxide film having a thickness of 100 nm or more and 1000 nm or less may be provided between the first optical waveguide and the second optical waveguide.

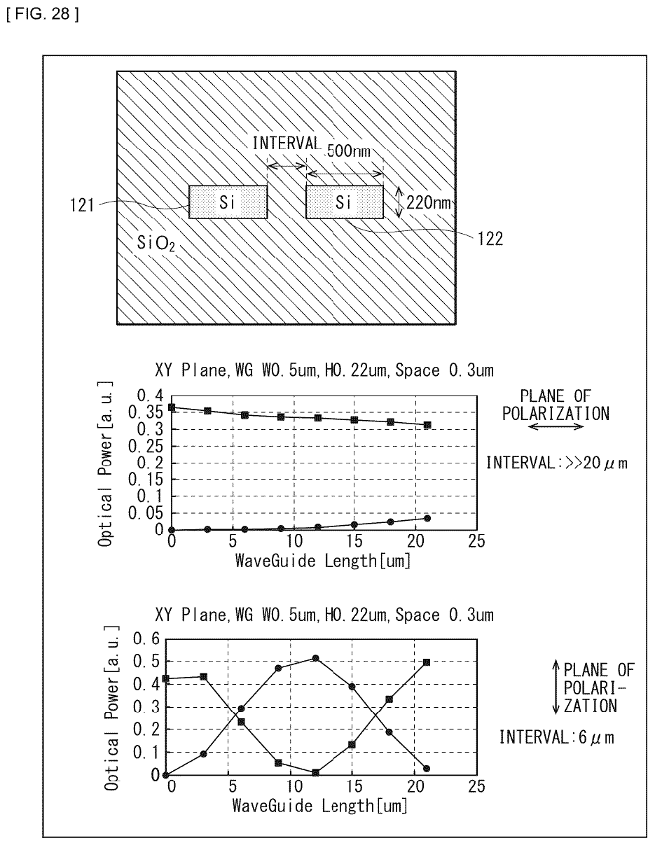

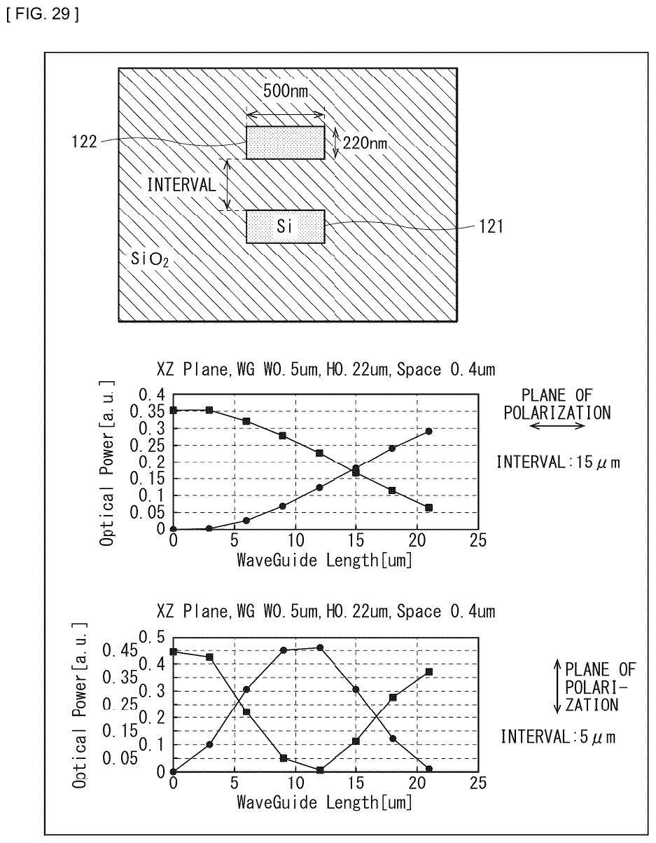

FIG. 28 schematically illustrates a characteristic example in a case where the two optical waveguides 121 and 122 are disposed in parallel in a plane by silicon photonics technology. FIG. 29 schematically illustrates a characteristic example in a case where the two optical waveguides 121 and 122 are disposed in a stacked state by silicon photonics technology.

In each of FIGS. 28 and 29, a result obtained from a simulation is illustrated. In the simulation, light is caused to enter one of the two optical waveguides 121 and 122 and a waveguide interval is simulated until a relative optical power of the two optical waveguides 121 and 122 reaches 50:50. In each of FIGS. 28 and 29, a result obtained from a simulation in each of a first and second planes of polarization is illustrated.

In a case where the two optical waveguides 121 and 122 are disposed in parallel in the plane (FIG. 28), the waveguide interval until the optical power reaches 50:50 is 20 μm or more for the first plane of polarization and is 6 m for the second plane of polarization 2.

In contrast, in a case where the two optical waveguides are disposed in a stacked state (FIG. 29), the waveguide interval until the optical power reaches 50:50 is 15 μm for the first plane of polarization and is 5 m for the second plane of polarization 2. As described above, the configuration of the two optical waveguides 121 and 122 disposed in a stacked state allows energy exchange by a relatively short waveguide, achieving a compact optical circuit for optical splitting or optical coupling with low loss.

### (Arrangement Example of Antennas)

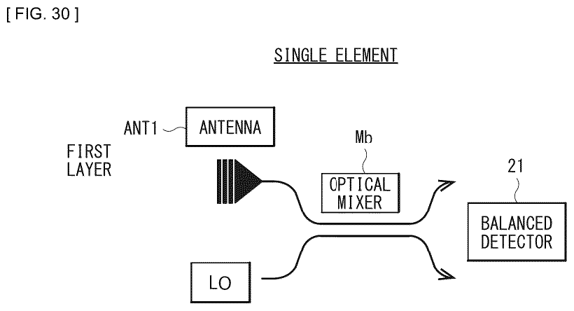

FIG. 30 is a planar diagram schematically illustrating one example of optical coupling by an optical waveguide of one antenna ANT1.

FIG. 30 illustrates a configuration example of a unit element for an optical signal from one antenna ANT1 and a reference signal L to be optically coupled by an optical waveguide and mixed, with heterodyne mixing, by an optical mixer Mb.

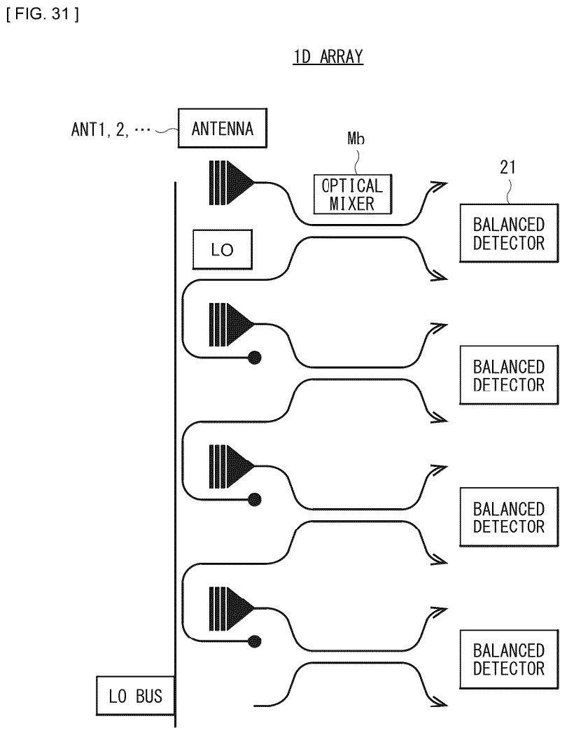

FIG. 31 is a planar diagram schematically illustrating one example of optical coupling by optical waveguides in an antenna array including a plurality of antennas ANT1, ANT2, . . . , ANTn arranged one-dimensionally (1D).

FIG. 31 illustrates a configuration example of a one-dimensional antenna array for respective optical signals from the plurality of antennas ANT1, ANT2, . . . , ANTn arranged one-dimensionally and a reference signal L to be optically coupled by optical waveguides and mixed, with heterodyne mixing, by an optical mixer Mb.

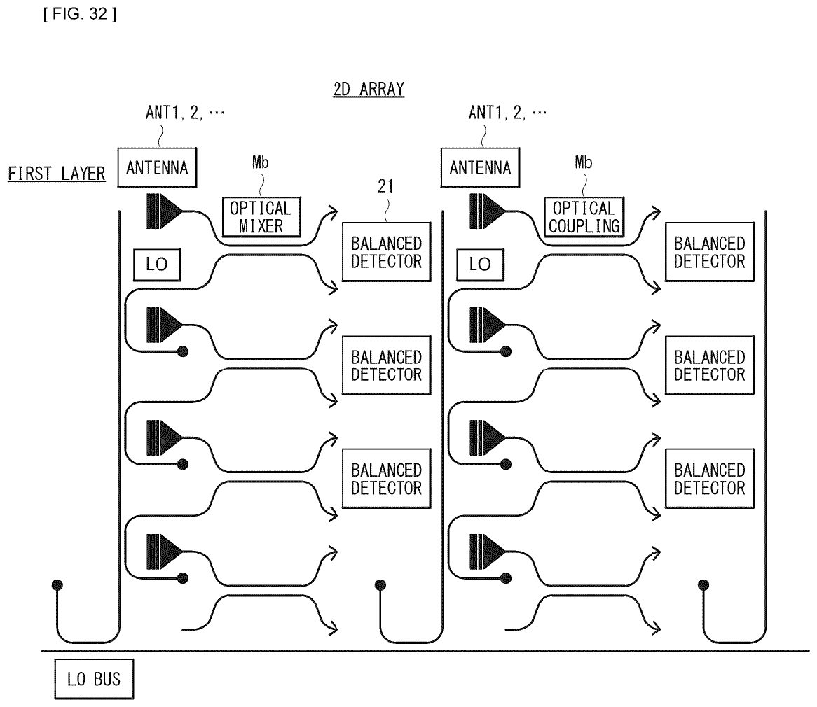

FIG. 32 is a planar diagram schematically illustrating one example of optical coupling by optical waveguides in an antenna array including a plurality of antennas ANT1, ANT2, . . . , ANTn arranged two-dimensionally (2D).

FIG. 32 illustrates a configuration example of a two-dimensional antenna array for respective optical signals from the plurality of antennas ANT1, ANT2, . . . , ANTn and reference signals L to be optically coupled by optical waveguides and mixed, with heterodyne mixing, by optical mixers Mb.

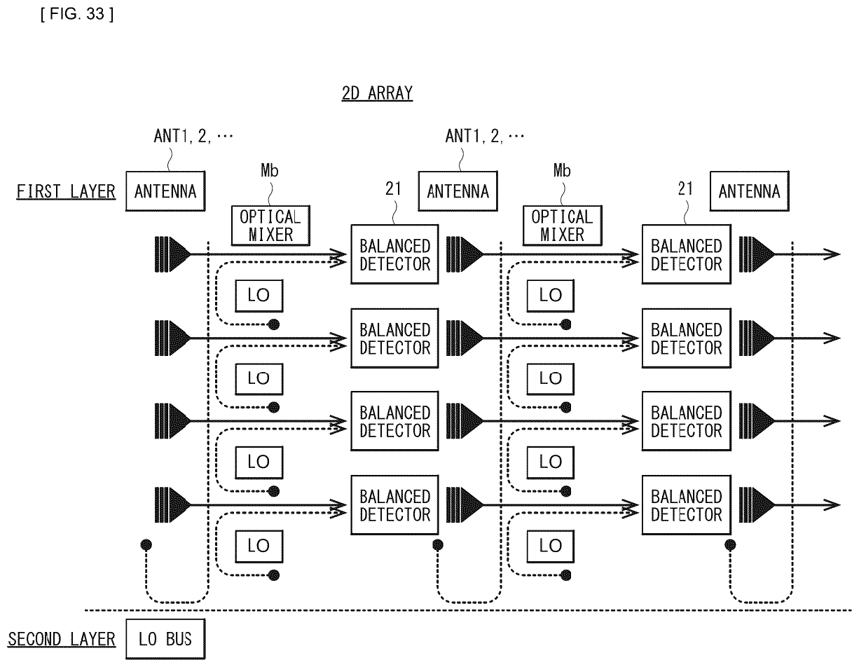

FIG. 33 is a planar diagram schematically illustrating a configuration example where optical signals from an antenna array including a plurality of antennas ANT1, ANT2, . . . , ANTn arranged two-dimensionally (2D) and reference signals LO are optically coupled by optical waveguides arranged in a stacked state.

FIG. 33 illustrates a configuration example of a two-dimensional antenna array for respective optical signals from the plurality of antennas ANT1, ANT2, . . . , ANTn and reference signals L to be optically coupled by optical waveguides arranged in a stacked state, and mixed, with heterodyne mixing, by optical mixers Mb. In the configuration example of FIG. 33, a first optical waveguide that guides an optical signal from each of the plurality of antennas ANT1, ANT2, . . . , ANTn and a second optical waveguide that guides each reference signal L are stacked at positions different from each other in the stacking direction.

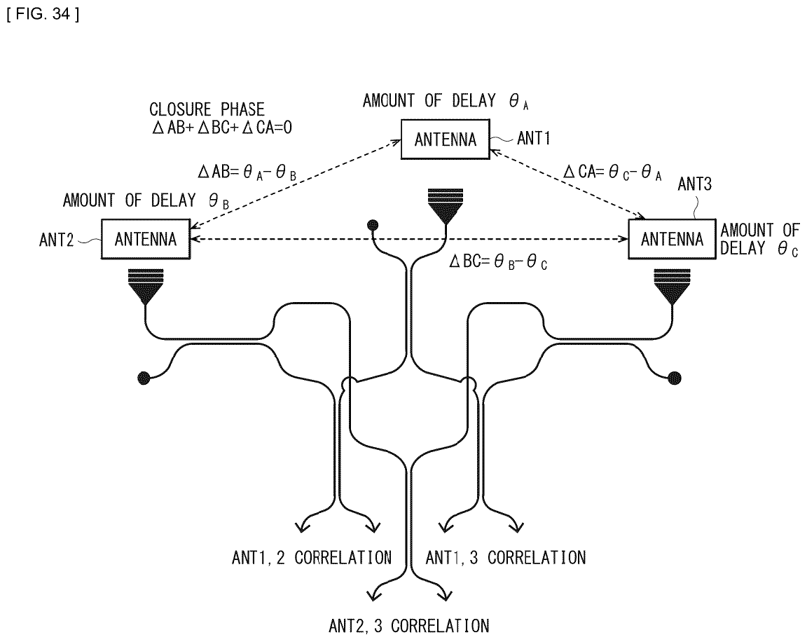

FIG. 34 is a planar diagram schematically illustrating a configuration example of optical coupling by optical waveguides in a case of taking cross-correlation signals of optical signals from three antennas ANT1, ANT2, and ANT3.

A configuration may be used that, in an optical mixer Ma, three or more cross-correlation signals obtained from three or more pairs formed by combining any two antennas out of three or more antennas ANT1, ANT2, . . . , ANTn are obtained. FIG. 34 illustrates an example of a configuration that three cross-correlation signals are obtained from a pair of antennas ANT1 and ANT2, a pair of antennas ANT1 and ANT3, and a pair of antennas ANT2 and ANT3.

Further, a configuration may be used that a sum of phase differences of three or more cross-correlation signals obtained from three or more pairs is in a relation of closure phase. Here also, in the example of FIG. 34, it is assumed that a delay amount of an optical signal obtained by the antenna ANT1 is θ_{A}, a delay amount of an optical signal obtained by the antenna ANT2 is θ_{B}, and a delay amount of an optical signal obtained by the antenna ANT3 is θ_{C}. A phase difference of an optical signal between two antennas ANT1 and ANT2 is ΔAB=θ_{A}−θ_{B}, a phase difference of an optical signal between two antennas ANT1 and ANT3 is ΔCA=θ_{C}−θ_{A}, and a phase difference of an optical signal between two antennas ANT2 and ANT3 is ΔBC=θ_{B}−θ_{C}. A sum of these three phase differences ΔAB, ΔBC, and ΔCA is configured to be in a relation of closure phase (ΔAB+ΔBC+ΔCA=0).

### (Example of Signal Processing of Optical Signal)

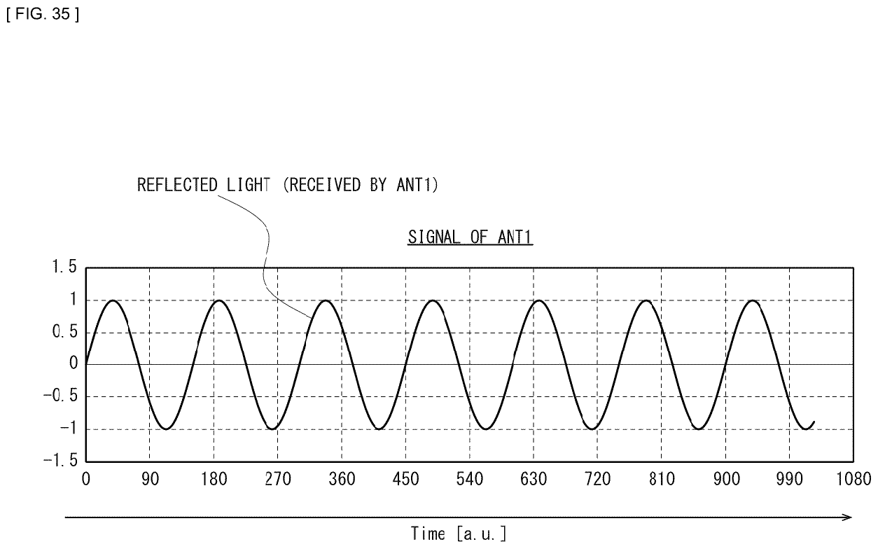

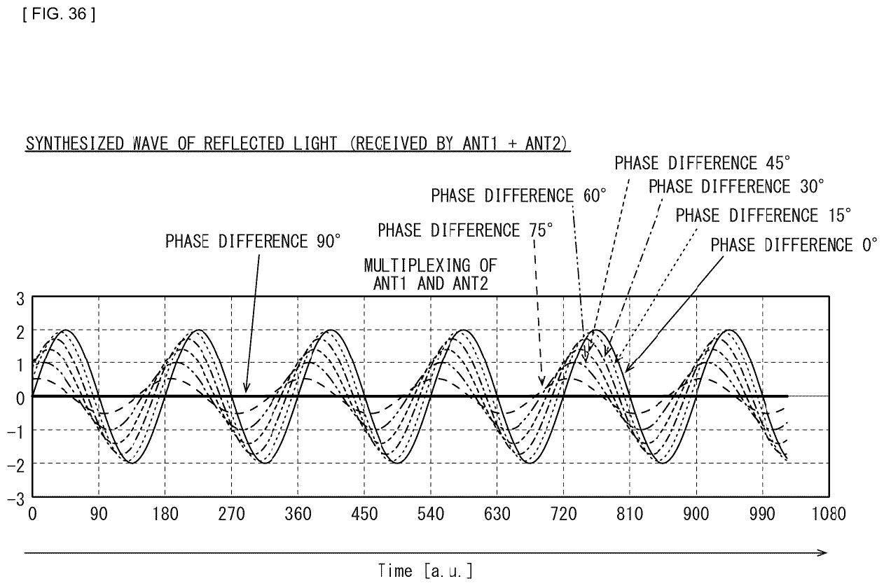

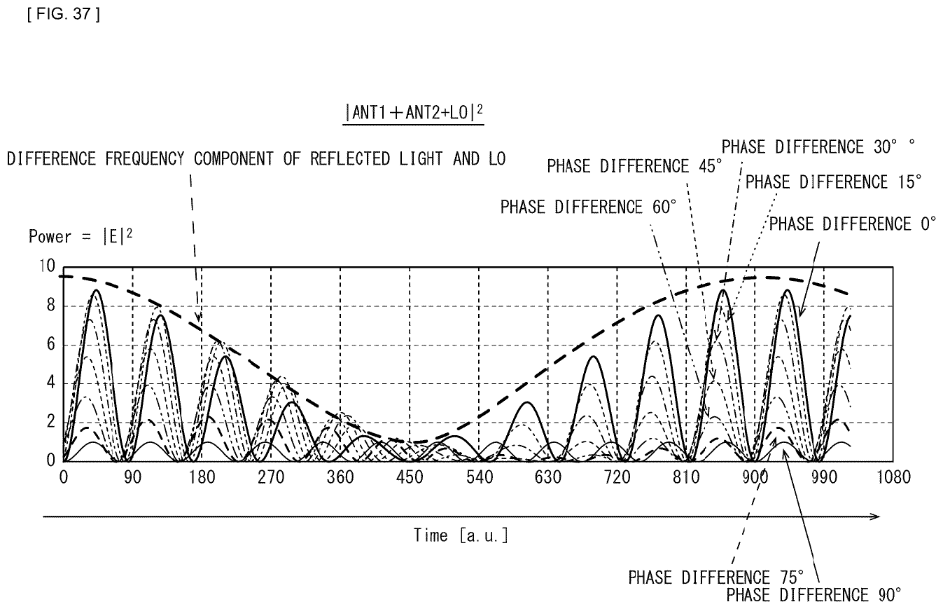

FIG. 35 illustrates one example of a waveform of an optical signal from one antenna ANT1. FIG. 36 illustrates one example of a waveform of a synthesized wave of optical signals from two antennas ANT1 and ANT2. FIG. 37 illustrates one example of an intensity waveform of a synthesized wave of optical signals from two antennas ANT1 and ANT2 and a reference signal LO.

As illustrated in FIG. 36, a synthesized wave of optical signals from two antennas ANT1 and ANT2 has different waveforms depending on phase differences. Thus, as illustrated in FIG. 37, an intensity waveform of a synthesized wave has also different waveforms depending of phase differences. FIG. 37 also illustrates a waveform of a difference frequency component between the optical signals from the two antennas ANT1 and ANT2 and the reference signal LO. The waveform of the difference frequency component depends on the phase differences.

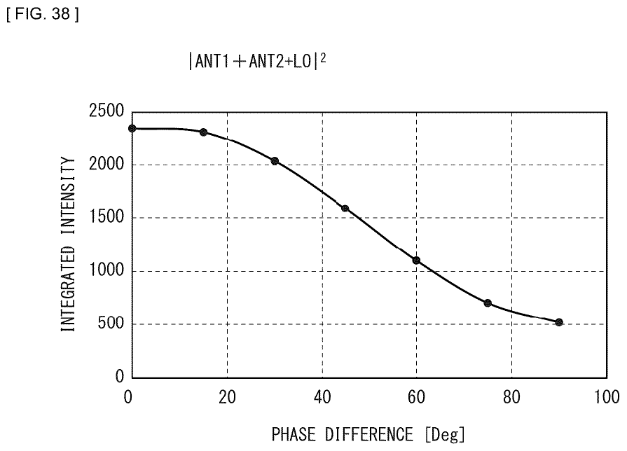

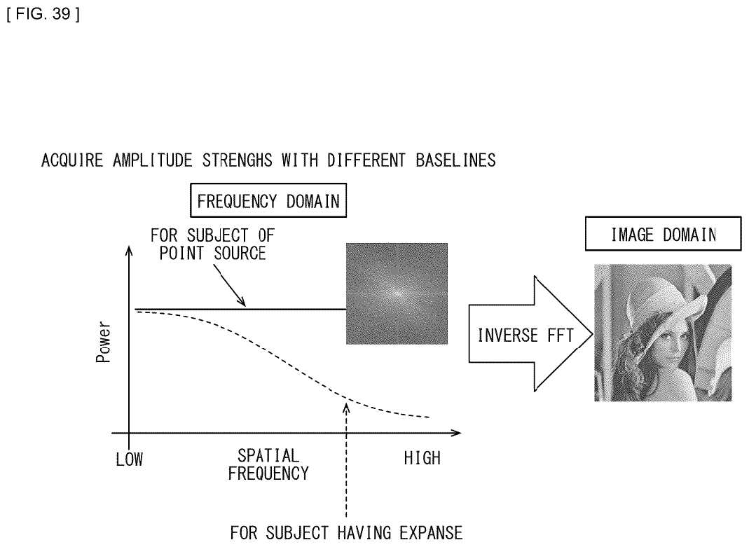

FIG. 38 illustrates one example of an intensity waveform of a synthesized wave of optical signals from two antennas ANT1 and ANT2 and a reference signal. FIG. 39 illustrates a relationship between imaging information in real space domain and a spatial frequency component in frequency domain.

On the left side in FIG. 39, a relationship between a spatial frequency and an optical power is illustrated. In a case where the subject 100 is a point source, the power is constant regardless of the spatial frequency. In a case where the subject 100 has a spread, the power varies regardless of the spatial frequency. For example, the signal processor 22 performs aperture synthesis processing including sampling, based on the difference frequency component, a spatial frequency component corresponding to a relative positional relationship between the light-receiving elements (antennas ANTn) in the any two photodetectors and converting the spatial frequency component into intensity distribution in real space by signal processing by inverse FFT (fast Fourier transform).

### 1.3 Effects

As described above, in the photodetection device and the ranging device according to one embodiment, two optical signals detected by arbitrary two antennas ANTn out of two or more antennas ANTn are mixed by an optical mixer Ma (cross-correlation section). Further, the optical signals after mixing by the cross-correlation section or one of the optical signals before mixing by the cross-correlation section and a reference signal LO obtained by dividing coherent light L1 from a laser light source 10 are mixed, with heterodyne mixing, by an optical mixer Mb (heterodyne correlation section). This allows high spatial resolution to be achieved.

Note that the effect described in this specification is only an example, which is not limited. Another effect may be present. This applies similarly to an effect of other embodiments below.

### 2. Other Embodiments

A technique according to the present disclosure is not limited to the description of one embodiment described above, and is modifiable in a variety of ways for implementation.

For example, the present technique is possible to have a configuration as below. According to the present technique with the configuration as below, two optical signals detected by any two photodetectors out of two or more photodetectors are mixed by a cross-correlation section. Further, the optical signals after mixing by the cross-correlation section or one of the optical signals before mixing by the cross-correlation section and a reference signal obtained by dividing coherent light from a laser light source are mixed, with heterodyne mixing, by a heterodyne correlation section. This allows high spatial resolution to be achieved.

(1)

A photodetection device including:
a laser light source that outputs coherent light;
two or more photodetectors including respective light-receiving elements, the light-receiving elements being disposed separated from one another, the two or more photodetectors detecting, via the light-receiving elements, reflected light from a subject irradiated with the coherent light;
a cross-correlation section that mixes two optical signals detected by any two photodetectors out of the two or more photodetectors; and
a heterodyne correlation section that mixes, with heterodyne mixing, the optical signals after mixing by the cross-correlation section or one of the optical signals before mixing by the cross-correlation section and a reference signal obtained by dividing the coherent light from the laser light source.
   (2)

The photodetection device according to (1), in which
the heterodyne correlation section mixes, with the heterodyne mixing, an optical signal detected by each of the two or more photodetectors and the reference signal, and
the cross-correlation section mixes any two optical signals after the heterodyne mixing by the heterodyne correlation section.
   (3)

The photodetection device according to (1) or (2), in which the reflected light is different in frequency from the reference signal.

(4)

The photodetection device according to any one of (1) to (3), in which
the photodetection device includes one or a plurality of functional blocks each including the any two photodetectors, the cross-correlation section, and the heterodyne correlation section, and
each of the functional blocks includes a function of sampling a spatial frequency component determined depending on a relative positional relationship between respective photodetection elements of the any two photodetectors.
   (5)

The photodetection device according to (3), in which a frequency difference between the reflected light and the reference signal is 10 GHz or less.

(6)

The photodetection device according to any one of (1) to (5), further including:
a balanced detector that converts the optical signals after the mixing by the cross-correlation section into an electric signal, in which
each of the two or more photodetectors is provided on a silicon substrate and includes a grating antenna in which the reflected light from free space enters, and
the grating antenna and the balanced detector are coupled with each other via an optical waveguide.
   (7)

The photodetection device according to any one of (1) to (6), in which each of the two or more photodetectors includes an optical lens function that allows a large effective detection area.

(8)

The photodetection device according to any one of (1) to (7), in which each of the two or more photodetectors includes an optical condensing mirror function that allows a large effective detection area.

(9)

The photodetection device according to any one of (1) to (8), in which each of the cross-correlation section and the heterodyne correlation section includes an optical path length adjustment function section that adjusts a phase difference of the optical signals or the reference signal.

(10)

The photodetection device according to any one of (1) to (9), in which
each of the two or more photodetectors is provided on a silicon substrate, and
the laser light source includes a coherent laser light source that emits light in a single mode of SWIR wavelength region of 1.1 μm or more and 2.0 μm or less.
   (11)

The photodetection device according to any one of (1) to (10), in which the laser light source includes a wavelength swept laser light source configured to continuously change a wavelength of the coherent light.

(12)

The photodetection device according any one of (1) to (11), further including:
a balanced detector that converts the optical signals after the mixing by the cross-correlation section into an electric signal, in which
the balanced detector performs current detection on a difference frequency component caused by a cross-correlation signal and the reference signal, the cross-correlation signal being generated by mixing in the cross-correlation section.
   (13)

The photodetection device according to (12), further including:
a signal processor that performs aperture synthesis processing, the aperture synthesis processing including sampling, on the basis of the difference frequency component, a spatial frequency component corresponding to a relative positional relationship between the light-receiving elements in the any two photodetectors and converting the spatial frequency component into intensity distribution in real space by signal processing.
   (14)

The photodetection device according to any one of (1) to (13), in which
each of the two or more photodetectors is provided on a silicon substrate, and
on the silicon substrate, a first optical waveguide that guides the reflected light and a second optical waveguide that guides the reference signal are stacked at positions different from each other in a stacking direction.
   (15)

The photodetection device according to (14), in which each of the first optical waveguide and the second optical waveguide mainly includes single crystal silicon or silicon nitride, and a flattening layer is provided between the first optical waveguide and the second optical waveguide on the silicon substrate, the flattening layer mainly including a silicone oxide film having a thickness of 100 nm or more and 1000 nm or less.

(16)

The photodetection device according to any one of (1) to (15), in which
the photodetection device includes, as the two or more photodetectors, three or more photodetectors, and
in the cross-correlation section, a sum of phase differences of three or more cross-correlation signals obtained from three or more pairs formed by combining any two of the three or more photodetectors is configured to be in a relation of closure phase.
   (17)

The photodetection device according any one of (1) to (16), further including:
a signal processor that calculates Doppler velocity of the subject in a sight direction of the two or more photodetectors on a basis of wavelength shift information regarding the coherent light calculated on the basis of a difference frequency component caused by a cross-correlation signal from the cross-correlation section and the reference signal.
   (18)

The photodetection device according to any one of (1) to (16), further including:
a signal processor that calculates distance information regarding the subject on the basis of a difference frequency component caused by a cross-correlation signal from the cross-correlation section and the reference signal, in which
the laser light source outputs, as the coherent light, laser light with a waveform chirped by wavelength conversion in a time direction.
   (19)

A ranging device including:
a laser light source that outputs coherent light;
two or more photodetectors including respective light-receiving elements, the light-receiving elements being disposed separated from one another, the two or more photodetectors detecting, via the light-receiving elements, reflected light from a subject irradiated with the coherent light;
a cross-correlation section that mixes two optical signals detected by any two photodetectors out of the two or more photodetectors;
a heterodyne correlation section that mixes, with heterodyne mixing, the optical signals after mixing by the cross-correlation section or one of the optical signals before mixing by the cross-correlation section and a reference signal obtained by dividing the coherent light from the laser light source; and
a signal processor that calculates distance information regarding the subject on a basis of a difference frequency component caused by a cross-correlation signal from the cross-correlation section and the reference signal.

The present application claims the benefit of Japanese Priority Patent Application JP2021-207156 filed with the Japan Patent Office on Dec. 21, 2021, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A photodetection device comprising:
a laser light source that outputs coherent light;
two or more photodetectors including respective light-receiving elements, the light-receiving elements being disposed separated from one another, the two or more photodetectors detecting, via the light-receiving elements, reflected light from a subject irradiated with the coherent light;
a cross-correlation section that mixes two optical signals detected by any two photodetectors out of the two or more photodetectors; and
a heterodyne correlation section that mixes, with heterodyne mixing, the optical signals after mixing by the cross-correlation section or one of the optical signals before mixing by the cross-correlation section and a reference signal obtained by dividing the coherent light from the laser light source.

2. The photodetection device according to claim 1, wherein
the heterodyne correlation section mixes, with the heterodyne mixing, an optical signal detected by each of the two or more photodetectors and the reference signal, and
the cross-correlation section mixes any two optical signals after the heterodyne mixing by the heterodyne correlation section.

3. The photodetection device according to claim 1, wherein the reflected light is different in frequency from the reference signal.

4. The photodetection device according to claim 1, wherein
the photodetection device includes one or a plurality of functional blocks each including the any two photodetectors, the cross-correlation section, and the heterodyne correlation section, and
each of the functional blocks includes a function of sampling a spatial frequency component determined depending on a relative positional relationship between respective photodetection elements of the any two photodetectors.

5. The photodetection device according to claim 3, wherein a frequency difference between the reflected light and the reference signal is 10 GHz or less.

6. The photodetection device according to claim 1, further comprising:
a balanced detector that converts the optical signals after the mixing by the cross-correlation section into an electric signal, wherein
each of the two or more photodetectors is provided on a silicon substrate and includes a grating antenna in which the reflected light from free space enters, and
the grating antenna and the balanced detector are coupled with each other via an optical waveguide.

7. The photodetection device according to claim 1, wherein each of the two or more photodetectors includes an optical lens function that allows a large effective detection area.

8. The photodetection device according to claim 1, wherein each of the two or more photodetectors includes an optical condensing mirror function that allows a large effective detection area.

9. The photodetection device according to claim 1, wherein each of the cross-correlation section and the heterodyne correlation section includes an optical path length adjustment function section that adjusts a phase difference of the optical signals or the reference signal.

10. The photodetection device according to claim 1, wherein
each of the two or more photodetectors is provided on a silicon substrate, and
the laser light source comprises a coherent laser light source that emits light in a single mode of SWIR wavelength region of 1.1 μm or more and 2.0 μm or less.

11. The photodetection device according to claim 1, wherein the laser light source comprises a wavelength swept laser light source configured to continuously change a wavelength of the coherent light.

12. The photodetection device according to claim 1, further comprising:
a balanced detector that converts the optical signals after the mixing by the cross-correlation section into an electric signal, wherein
the balanced detector performs current detection on a difference frequency component caused by a cross-correlation signal and the reference signal, the cross-correlation signal being generated by mixing in the cross-correlation section.

13. The photodetection device according to claim 12, further comprising:
a signal processor that performs aperture synthesis processing, the aperture synthesis processing including sampling, on a basis of the difference frequency component, a spatial frequency component corresponding to a relative positional relationship between the light-receiving elements in the any two photodetectors and converting the spatial frequency component into intensity distribution in real space by signal processing.

14. The photodetection device according to claim 1, wherein
each of the two or more photodetectors is provided on a silicon substrate, and
on the silicon substrate, a first optical waveguide that guides the reflected light and a second optical waveguide that guides the reference signal are stacked at positions different from each other in a stacking direction.

15. The photodetection device according to claim 14, wherein each of the first optical waveguide and the second optical waveguide mainly includes single crystal silicon or silicon nitride, and a flattening layer is provided between the first optical waveguide and the second optical waveguide on the silicon substrate, the flattening layer mainly including a silicone oxide film having a thickness of 100 nm or more and 1000 nm or less.

16. The photodetection device according to claim 1, wherein
the photodetection device includes, as the two or more photodetectors, three or more photodetectors, and
in the cross-correlation section, a sum of phase differences of three or more cross-correlation signals obtained from three or more pairs formed by combining any two of the three or more photodetectors is configured to be in a relation of closure phase.

17. The photodetection device according to claim 1, further comprising:
a signal processor that calculates Doppler velocity of the subject in a sight direction of the two or more photodetectors on a basis of wavelength shift information regarding the coherent light calculated on a basis of a difference frequency component caused by a cross-correlation signal from the cross-correlation section and the reference signal.

18. The photodetection device according to claim 1, further comprising:
a signal processor that calculates distance information regarding the subject on a basis of a difference frequency component caused by a cross-correlation signal from the cross-correlation section and the reference signal, wherein
the laser light source outputs, as the coherent light, laser light with a waveform chirped by wavelength conversion in a time direction.

19. A ranging device comprising:
a laser light source that outputs coherent light;
two or more photodetectors including respective light-receiving elements, the light-receiving elements being disposed separated from one another, the two or more photodetectors detecting, via the light-receiving elements, reflected light from a subject irradiated with the coherent light;
a cross-correlation section that mixes two optical signals detected by any two photodetectors out of the two or more photodetectors;
a heterodyne correlation section that mixes, with heterodyne mixing, the optical signals after mixing by the cross-correlation section or one of the optical signals before mixing by the cross-correlation section and a reference signal obtained by dividing the coherent light from the laser light source; and
a signal processor that calculates distance information regarding the subject on a basis of a difference frequency component caused by a cross-correlation signal from the cross-correlation section and the reference signal.
